(19) United States
(12) Patent Application Publication
(10) Pub. No.: US 2024/0381350 A1
(43) Pub. Date: Nov. 14, 2024

(54) COMMUNICATION METHOD AND TERMINAL DEVICE

(71) Applicant: SPREADTRUM SEMICONDUCTOR (NANJING) CO., LTD., Nanjing (CN)

(72) Inventors: Zhenzhu LEI, Nanjing, Jiangsu (CN); Huayu ZHOU, Nanjing, Jiangsu (CN)

(21) Appl. No.: 18/778,415

(22) Filed: Jul. 19, 2024

Related U.S. Application Data
(63) Continuation of application No. PCT/CN2023/072926, filed on Jan. 18, 2023.

(30) Foreign Application Priority Data
Jan. 21, 2022 (CN) 202210074810.6

(51) Int. Cl. H04W 72/1268; H04L 5/00; H04W 56/00; H04W 74/0833

(52) U.S. Cl. CPC H04W 72/1268; H04L 5/0051; H04W 56/0015; H04W 74/0833

(57) ABSTRACT

A communication method and apparatus, and a terminal device are provided. The method includes the following. Determine a first random access request message (message A, MsgA) physical uplink shared channel (PUSCH) resource set and a first repetition number of MsgA PUSCH, where the first MsgA PUSCH resource set corresponds to R PUSCH occasions (PO) in time domain and one demodulation reference signal (DMRS) resource or one DMRS resource set. Determine a PO from the first MsgA PUSCH resource set according to the first repetition number of MsgA PUSCH to perform MsgA PUSCH transmission.

### CROSS-REFERENCE TO RELATED APPLICATION(S)

This application is a continuation of International Application No. PCT/CN2023/072926, filed Jan. 18, 2023, which claims priority to Chinese application No. 2022100748106, files Jan. 21, 2022, the entire disclosures of which are incorporated herein by reference.

### TECHNICAL FIELD

The disclosure relates to the field of communication technology, and more particularly, to a communication method and a terminal device.

### BACKGROUND

In the protocol standard specified by the 3^{rd} generation partnership project (3GPP), uplink coverage enhancement is introduced for transmission in a wireless communication system.

In a 2-step random access procedure, a terminal device can send a random access message (i. e. message A (MsgA)) and receive a random access response (RAR) message (i. e. message B (MsgB)).

The MsgA can include a physical random access channel (PRACH) preamble and uplink data. The PRACH preamble can also be referred to as a MsgA PRACH. The uplink data can also be referred to as a MsgA physical uplink shared channel (PUSCH) or a MsgA PUSCH payload.

However, how to implement uplink coverage enhancement in a 2-step random access procedure needs to be further studied.

### SUMMARY

In a first aspect, a communication method in the disclosure is provided. The method is applied to a terminal device. The method includes the following. Determine a first random access request message (message A, MsgA) physical uplink shared channel (PUSCH) resource set and a first repetition number of MsgA PUSCH, where the first MsgA PUSCH resource set corresponds to R PUSCH occasions (PO) in time domain and one demodulation reference signal (DMRS) resource or one DMRS resource set. Determine a PO from the first MsgA PUSCH resource set according to the first repetition number of MsgA PUSCH to perform MsgA PUSCH transmission.

In a second aspect, a communication method in the disclosure is provided. The method is applied to a terminal device. The method includes the following. Determine a first repetition number of physical uplink control channel (PUCCH) for hybrid automatic repeat request-acknowledgement (HARQ-ACK) feedback information corresponding to a random access response (RAR) message (message B, MsgB).

In a third aspect, a communication apparatus in the disclosure is provided. The apparatus includes a determining unit and a transmitting unit. The determining unit is configured to determine a MsgA PUSCH resource set and a first repetition number of MsgA PUSCH, where the first MsgA PUSCH resource set corresponds to R POs in time domain and one DMRS resource or one DMRS resource set. The transmitting unit is configured to determine a PO from the first MsgA PUSCH resource set according to the first repetition number of MsgA PUSCH to perform MsgA PUSCH transmission.

In a fourth aspect, a communication apparatus in the disclosure is provided. The apparatus includes a determining unit. The determining unit is configured to determine a first repetition number of PUCCH for HARQ-ACK feedback information corresponding to MsgB.

In a fifth aspect, a terminal device in the disclosure is provided. The terminal device includes a processor, a memory, and computer programs or instructions stored in the memory. The computer programs or instructions, when executed by the processor, are operable to implement the method in the first aspect or the second aspect.

In a sixth aspect, a chip in the disclosure is provided. The chip includes a processor. The processor is configured to perform the method in the first aspect or the second aspect.

In a seventh aspect, a chip module in the disclosure is provided. The chip module includes a transceiver component and a chip. The chip includes a processor, where the processor is configured to perform the method in the first aspect or the second aspect.

In an eighth aspect, a computer-readable storage medium in the disclosure is provided. The computer-readable storage medium stores computer programs or instructions which, when executed, are operable to perform the method in the first aspect or the second aspect.

In a ninth aspect, a computer program product in the disclosure is provided. The computer program includes computer programs or instructions which, when executed, are operable to implement the method in the first aspect or the second aspect. Exemplarily, the computer program product can be a software installation package.

### BRIEF DESCRIPTION OF THE DRAWINGS

To describe more clearly technical solutions of embodiments of the disclosure, the following will give a brief introduction of the accompanying drawings used for describing the embodiments of the disclosure.

FIG. 1 is a schematic architectural diagram of a wireless communication system according to embodiments of the disclosure.

FIG. 2 is a schematic architectural diagram of a communication system with a transparent satellite according to embodiments of the disclosure.

FIG. 3 is a schematic structural diagram illustrating beams generated by a satellite onto a ground according to embodiments of the disclosure.

FIG. 4 is a schematic structural diagram illustrating comparison between a terrestrial network communication system and a non-terrestrial network (NTN) communication system in terms of signal received quality according to embodiments of the disclosure.

FIG. 5 is a schematic diagram illustrating comparison between architectures of different NTN communication systems according to embodiments of the disclosure.

FIG. 6 is a schematic flowchart illustrating contention-based 4-step random access according to embodiments of the disclosure.

FIG. 7 is a schematic flowchart illustrating contention-based 2-step random access according to embodiments of the disclosure.

FIG. 8 is another schematic flowchart illustrating contention-based 2-step random access according to embodiments of the disclosure.

FIG. 9 is a schematic structural diagram illustrating physical uplink shared channel occasion (PUSCH occasion, PO) configuration according to embodiments of the disclosure.

FIG. 10 is a schematic structural diagram illustrating PO sets per association pattern period according to embodiments of the disclosure.

FIG. 11 is a schematic structural diagram illustrating physical random access channel occasion (PRACH occasion, RO) sets per association pattern period according to embodiments of the disclosure.

FIG. 12 is a schematic flowchart of a communication method according to embodiments of the disclosure.

FIG. 13 is a schematic flowchart of another communication method according to embodiments of the disclosure.

FIG. 14 is a block diagram illustrating functional units of a communication apparatus according to embodiments of the disclosure.

FIG. 15 is a block diagram illustrating functional units of another communication apparatus according to embodiments of the disclosure.

FIG. 16 is a schematic structural diagram of a terminal device according to embodiments of the disclosure.

FIG. 17 is a schematic structural diagram of another terminal device according to embodiments of the disclosure.

### DETAILED DESCRIPTION

It should be understood that, terms such as “first” and “second” in embodiments of the disclosure are used to distinguish different objects rather than describe a specific order. In addition, terms “include”, “comprise”, and “have” as well as variations thereof are intended to cover non-exclusive inclusion. For example, a process, method, software, product, or device including a series of steps or units is not limited to the listed steps or units, and instead, it can optionally include other steps or units that are not listed or other steps or units inherent to the process, method, product, or device.

The term “embodiment” referred to in embodiments of the disclosure means that a particular feature, structure, or characteristic described in conjunction with the embodiment can be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein can be combined with other embodiments.

The term “and/or” herein only describes an association between associated objects, which means that there can be three relationships. For example, A and/or B can mean A alone, both A and B exist, and B alone, where A and Beach can be a singular form or a plural form. In addition, the character “/” herein generally indicates that the associated objects are in an “or” relationship. In addition, the symbol “/” can represent a divisor, that is, perform a division operation.

The term “at least one (item) of” or the like in embodiments of the disclosure refers to any combination of these items, including any combination of a single item or multiple items. For example, at least one (item) of a, b, or c can represent the following seven cases: a; b; c; a and b; a and c; b and c; a, b, and c. a, b, and c each can be an element or a set including one or more elements.

“Of”, “corresponding/relevant”, “corresponding”, “indicated”,

“associated/related”, “mapped”, “configured”, and “allocated” in embodiments of the disclosure can be used interchangeably sometimes. It should be noted that, they represent the same concept or meaning when there is no emphasis laid on their difference.

The terms “network” and “system” in embodiments of the disclosure can be expressed as the same concept, and a communication system is a communication network.

The “connection” in embodiments of the disclosure refers to various manners of connection, such as direct connection or indirect connection, so as to implement communication between devices, which is not limited herein.

Contents related to technical solutions of embodiments of the disclosure will be elaborated below.

### I. Wireless Communication System, Terminal Device, Satellite, Non-Terrestrial Network (NTN) Gateway, and Network Device

### 1) Wireless Communication System

The technical solutions of embodiments of the disclosure are applicable to various wireless communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, an NTN system, a universal mobile telecommunication system (UMTS), a wireless local area network (WLAN), a wireless fidelity (WiFi), a 6^{th}-generation (6G) communication system, or other communication systems, etc.

A conventional wireless communication system generally supports a limited quantity of connections and therefore is easy to implement. However, with development of communication technology, a wireless communication system will not only support conventional wireless communication but also support, for example, device to device (D2D) communication, machine to machine (M2M) communication, machine type communication (MTC), vehicle to vehicle (V2V) communication, or vehicle to everything (V2X) communication, narrowband internet of things (NB-IoT) communication, etc. Embodiments of the disclosure can also be applied to these wireless communication systems.

Exemplarily, embodiments of the disclosure can be applied to a beamforming, carrier aggregation (CA), dual connectivity (DC), or standalone (SA) deployment scenario.

Exemplarily, embodiments of the disclosure can be applied to an unlicensed spectrum, where the unlicensed spectrum can also be considered as a shared spectrum in embodiments of the disclosure. Alternatively, the wireless communication system in the embodiments of the disclosure can also be applied to a licensed spectrum, where the licensed spectrum can also be considered as a non-shared spectrum.

In some possible implementations, the technical solutions of the embodiments of the disclosure can be applied to an NTN communication system, and the NTN communication system generally provides communication service for a ground terminal device by means of satellite communication.

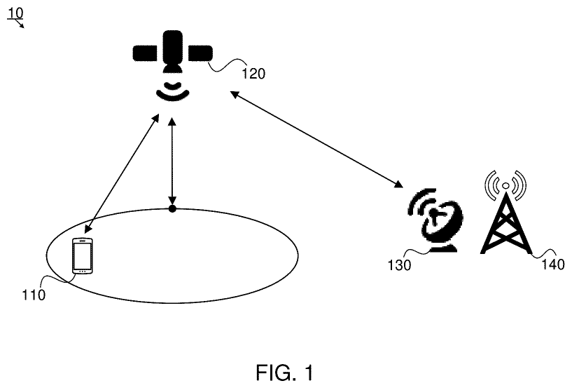

Exemplarily, an NTN communication system in embodiments of the disclosure is illustrated in FIG. 1. The NTN communication system 10 can include a terminal device 110, a satellite 120, an NTN gateway 130, and a network device 140. The terminal device 110, the NTN gateway 130, and the network device 140 can be located on the surface of the Earth while the satellite 120 is located on the orbit of the Earth. The satellite 120 can provide communication service to a geographic area covered by a signal and can communicate with the terminal device(s) 110 located within the signal coverage area.

Further, the terminal device 110 is located in a certain cell or beam. In addition, a wireless communication link between the terminal device 110 and the satellite 120 is referred to as a service link, and a wireless communication link between the satellite 120 and the NTN gateway 130 is referred to as a feeder link.

It should be noted that, the NTN gateway 130 and the network device 140 can be integrated into the same device, or can be separate devices, which is not limited herein.

### 2) Terminal Device

In the embodiments of the disclosure, the terminal device can be a device having transceiver functions, and can also be referred to as a user equipment (UE), a remote UE, a relay UE, an access terminal device, a subscriber unit, a subscriber station, a mobile station, a remote station, a mobile device, a user terminal device, a smart terminal device, a wireless communication device, a user agent, or a user apparatus. It should be noted that, the relay device is a terminal device that can provide relay forwarding service for other terminal devices (including a remote terminal device).

In addition, the terminal device can be a cellular telephone, a cordless telephone, a session initiation protocol (SIP) telephone, or a wireless local loop (WLL) station, a personal digital assistant (PDA), various devices having wireless communication functions such as a handheld device, a computing device or other processing device connected to a wireless modem, an in-vehicle device, a wearable device, a terminal device in a next generation communication system (e. g., an NR communication system, a 6G communication system), or a terminal device in a future evolved public land mobile network (PLMN), which is not limited herein.

In embodiments of the disclosure, the terminal device can be deployed on land, which includes indoor or outdoor, handheld, wearable, or in-vehicle. The terminal device can also be deployed on water (such as ships, etc.). The terminal device can also be deployed in the air (such as airplanes, balloons, satellites, etc.).

In embodiments of the disclosure, the terminal device can be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

In embodiments of the disclosure, the terminal device can include a device having wireless communication functions, such as a system-on-chip (SOC), a chip, and a chip module. Exemplarily, the SOC can include a chip, and can further include other discrete components.

### 3) Satellite

In embodiments of the disclosure, a satellite can be a spacecraft carrying a transparent payload (or referred to as a bent pipe payload) or regenerative payload signal transmitter.

The satellites typically operate at a low earth orbit (LEO) with a height between 300 and 1500 kilometers (km), a medium earth orbit (MEO) with a height between 7000 and 25000 km, a geostationary earth orbit (GEO) with a height of 35786 km, or a high elliptical orbit (HEO) with a height between 400 and 50000 km.

That is, the satellite can be an LEO satellite, an MEO satellite, a GEO satellite, an HEO satellites, or the like according to difference in orbital altitude.

In embodiments of the disclosure, signals sent by the satellite usually generate one or more beams (namely, beam footprint) in a given service area with a field of view of the satellite as a boundary. In addition, the shape of a beam on the ground can be elliptical, and the field of view of the satellite depends on the antenna and the minimum elevation angle.

### 4) NTN Gateway

In embodiments of the disclosure, the NTN gateway can be an Earth station or a gateway located on the surface of the Earth, and can provide sufficient radio frequency (RF) power and RF sensitivity to connect satellites. In addition, the NTN gateway can be a transport network layer (TNL) node.

### 5) Network Device

In embodiments of the disclosure, the network device can be a device having transceiver functions. The network device can be a device for communicating with the terminal device, and is responsible for radio resource management (RRM), quality of service (QOS) management, data compression and encryption, and data transmission and reception, etc. at an air-interface side. The network device can be a base station (BS) in a communication system, or a device deployed in a radio access network (RAN) for providing wireless communication functions, for example, a base transceiver station (BTS) in a GSM or CDMA communication system, a node B (NB) in a WCDMA communication system, and an evolutional node B (eNB or eNodeB) in an LTE communication system, a next generation evolved node B (ng-eNB) in an NR communication system, and a next generation node B (gNB) in an NR communication system, a master node (MN) in a DC architecture, a second node or a secondary node (SN) in a DC architecture, and the like, which is not limited herein.

In embodiments of the disclosure, the network device can also be other devices in a core network (CN), such as an access and mobility management function (AMF), a user plane function (UPF), etc., or can be an access point (AP) in a WLAN, a relay station, a communication device in a future evolved PLMN network, a communication device in an NTN network, and the like.

In embodiments of the disclosure, the network device can include an apparatus for providing wireless communication functions for the terminal device, such as an SOC, a chip, and a chip module. Exemplarily, the SOC can include a chip, and can further include other discrete components.

In embodiments of the disclosure, the network device can communicate with an internet protocol (IP) network, for example, the Internet, a private IP network, or other data networks.

In some possible network deployments, the network device can be an independent node to implement all functions of the base station, and can include a centralized unit (CU) and distributed units (DU), such as a gNB-CU and a gNB-DU. The network device can further include an active antenna unit (AAU). The CU can implement some functions of the network device, and the DU can implement some other functions of the network device. For example, the CU is responsible for processing non-real-time protocols and services, and implements functions of a radio resource control (RRC) layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a media access control (MAC) layer, and functions of a PHY layer. In addition, the AAU implements some PHY layer processing functions, RF processing functions, and active-antenna related functions. Since RRC layer information will eventually become PHY layer information, or is transformed from PHY layer information, in such network deployment, it can be considered that higher-layer signaling, such as RRC layer signaling, is transmitted by the DU, or transmitted by the DU and the AAU. It can be understood that, the network device can be a device including one or more of a CU node, a DU node, and an AAU node. In addition, the CU can be categorized as a network device in a RAN, or can be categorized as a network device in a CN, and the disclosure is not limited in this regard.

In embodiments of the disclosure, the network device serves a cell, and the terminal device in the cell communicates with the network device on a transmission resource (for example, a spectrum resource). The cell can include a macro cell, a small cell, a metro cell, a micro cell, a pico cell, a femto cell, etc.

### 6) Exemplary Illustration

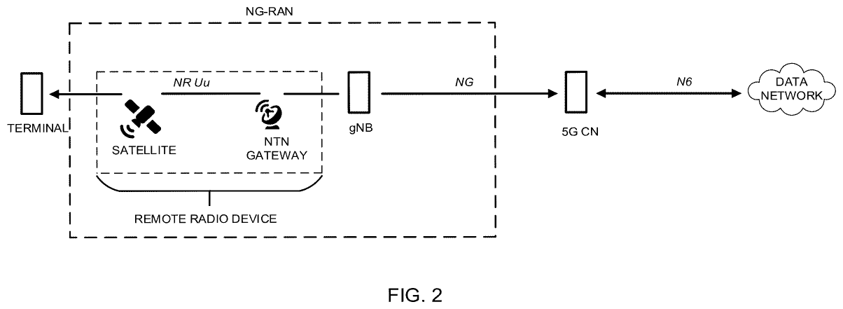

Exemplarily, FIG. 2 is a schematic architectural diagram of a communication system with a transparent satellite according to embodiments of the disclosure. The terminal device, the NTN gateway, and the gNB are located on the surface of the Earth, while the satellite is located on the orbit of the Earth. In addition, the satellite, the NTN gateway, and the gNB can serve as a 5G RAN (next-generation (NG)-RAN), and the NG-RAN is connected to a 5G CN via an NG interface.

It should be noted that, the satellite payload implements frequency conversion and a radio frequency amplifier in both uplink and downlink directions, and the satellite can be an analog RF repeater. In addition, different transparent satellites can be connected to the same gNB on the ground.

### II. NTN Communication System

### (1) Difference Between NTN Communication System and Terrestrial Network Communication System

In an NTN communication system, a satellite usually generates one or more beams (namely, beam footprint) or cells on the ground, and the shape of one beam on the ground can be an ellipse. A beam or cell generated by some satellites (e. g., an LEO satellite) on the ground can move on the ground as the satellite moves along its orbit. Alternatively, a beam or cell generated by some satellites (e. g., a LEO satellite or a GEO satellite) on the ground may not move on the ground as the satellite moves along its orbit.

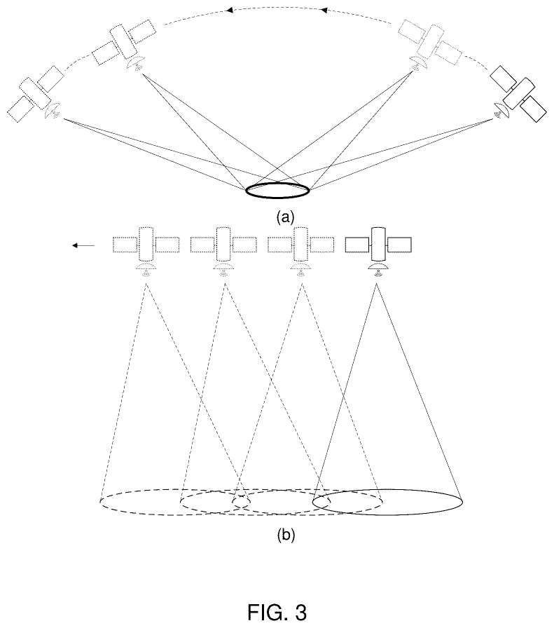

For example, as illustrated in FIG. 3, in (a) of FIG. 3, a satellite (e. g., a LEO satellite or a GEO satellite) generates a beam on the ground that does not move on the ground as the satellite moves along its orbit. In (b) of FIG. 3, the beam generated by the satellite on the ground moves on the ground as the satellite moves along its orbit, and a relative distance between the satellite and the beam generated by the satellite is fixed, so that a pathloss value varies slightly.

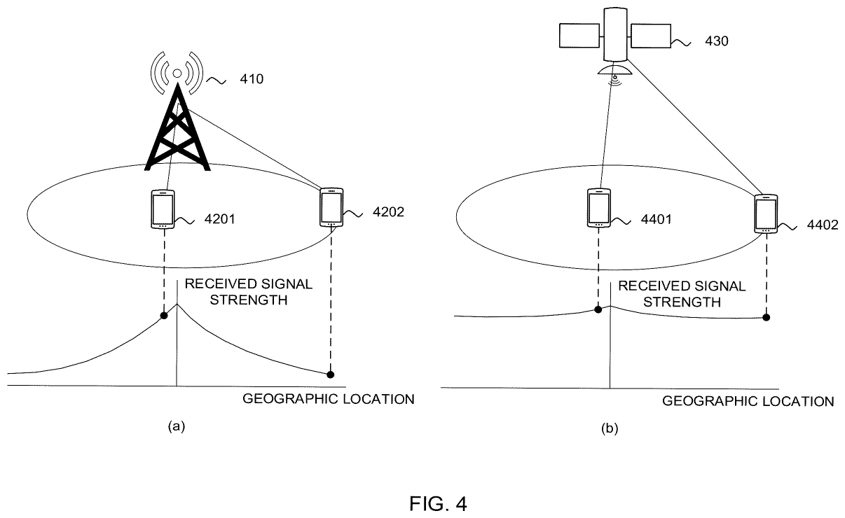

Because the distance from the satellite to the ground is very long (for example, 35786 km for a GEO satellite), therefore, within the coverage range of the same beam or cell, the difference of propagation distances between terminals (such as UEs) in different geographic locations and satellites is relatively small (namely, the difference of pathlosses of signals corresponding to terminals in different geographic locations within the coverage range of the same beam/cell is relatively small), as a result, there is a very small difference between the signal received qualities (including the downlink received quality of the terminal or the uplink received quality of the base station) corresponding to terminals at different geographic locations within the coverage area of the same beam/cell, as illustrated in FIG. 4.

In the terrestrial network communication system illustrated in (a) of FIG. 4, there are a terminal device 4201 and a terminal device 4202 in different geographic locations within the coverage area of the same beam/cell.

Because there is a large difference between the propagation distance from a network device 410 to the terminal device 4201 and the propagation distance from the network device 410 to the terminal device 4202, there is a large difference between the signal received quality corresponding to the terminal device 4201 and the signal received quality corresponding to the terminal device 4202.

In the NTN communication system illustrated in (b) of FIG. 4, there are a terminal device 4401 and a terminal device 4402 in different geographic locations within the coverage area of the same beam/cell. Because the distance from a satellite 430 to the ground is very long, there is a small difference between the propagation distance from the satellite 430 to the terminal device 4401 and the propagation distance from the satellite 430 to the terminal device 4402, and as a result, there is a small difference between the signal received quality corresponding to the terminal device 4401 and the signal received quality corresponding to the terminal device 4402.

### (2) Architecture of NTN Communication System

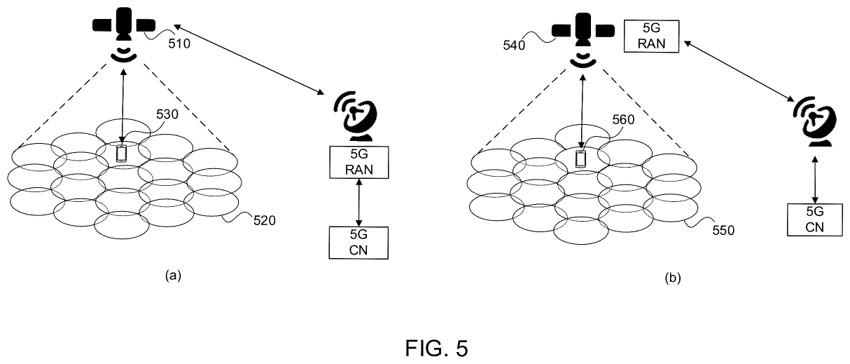

The architecture of the NTN communication system in embodiments of the disclosure mainly includes an NTN communication architecture with a transparent satellite (or referred to as a bent pipe payload) (namely, a transparent mode) and an NTN communication architecture with a regenerative satellite (namely, a regenerative mode), as illustrated in FIG. 5. (a) of FIG. 5 illustrates an NTN communication architecture with a transparent satellite, and (b) of FIG. 5 illustrates an NTN communication architecture with a regenerative satellite.

In (a) of FIG. 5, a satellite 510 in the transparent mode generates at least one beam 520 on the ground, and the at least one beam 520 can form a cell on the ground. In this case, a terminal 530 within the cell can measure one of all beams of the cell and establish a communication connection with the satellite 510 via the beam.

Likewise, in (b) of FIG. 5, a satellite 540 in the regenerative mode generates at least one beam 550 on the ground, and the at least one beam 550 can form a cell on the ground. In this case, a terminal 560 within the cell can measure one of all the beams of the cell and establish a communication connection with the satellite 540 via the beam.

### III. Random Access Procedure

### (1) Contention-Based 4-Step Random Access Procedure

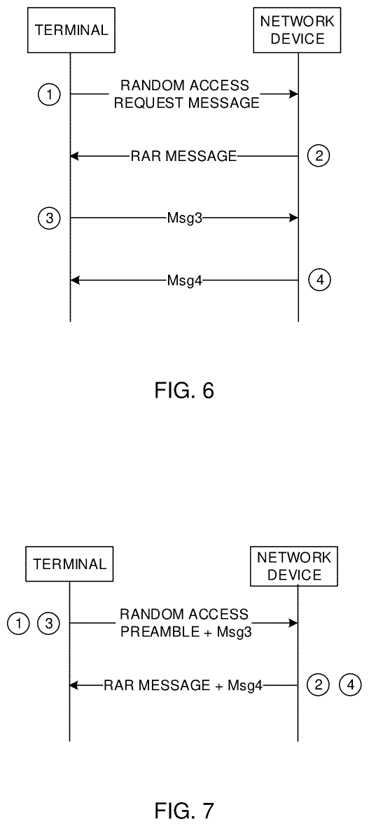

As illustrated in FIG. 6, for contention-based 4-step random access, the procedure thereof includes four steps: transmit a random access request message, transmit a random access response (RAR) message, transmit message 3 (Msg3), and transmit message 4 (Msg4).

Step I, transmit a random access request message.

The random access request message is message 1 (Msg1).

Specifically, the random access request message can include a physical random access channel (PRACH) preamble.

The PRACH preamble can be mainly used to notify to the network device that there is a random access request, so that the network device can estimate a transmission delay between the network device and the terminal device, align uplink time accordingly, and indicate to the terminal device via an RAR message.

Step II, transmit the RAR message.

The RAR message, i. e. message 2 (Msg2), is transmitted on a physical downlink shared channel (PDSCH) payload resource, and is scrambled by a random access radio network temporary identifier (RA-RNTI), where the value of the RA-RNTI depends on a time-frequency location of a resource carrying the PRACH preamble.

The RA-RNTI can be calculated according to a PRACH occasion (RO) and a frequency resource.

After transmitting the PRACH preamble, the terminal device monitors a corresponding physical downlink control channel (PDCCH) within an RAR time window according to the value of the RA-RNTI to obtain downlink control information (DCI), and then parses the PDSCH payload with the RA-RNTI according to the DCI, to receive a corresponding RAR message scrambled by the RA-RNTI. If the RAR message sent by the network device is not received within the RAR time window, it is considered that the random access procedure failed.

The RAR message can contain a time adjustment amount (such as a timing advance (TA)) required for uplink synchronization, an uplink resource required for the terminal device to transmit the Msg3, a temporary cell-RNTI (TC-RNTI), power adjustment, etc.

In addition, since the terminal device can randomly select a PRACH preamble for random access, the same PRACH resource and the same PRACH preamble are likely to be selected by multiple terminal devices at the same time, thus resulting in collision, that is, which terminal device the RAR message is directed to cannot be determined when using the same RA-RNTI and the same PRACH preamble. In this case, a contention resolution mechanism is needed for handling such collision.

The first two steps, i. e. the Msg1 and the Msg2, of the random access procedure are mainly intended for completing uplink time synchronization, while Msg3 and Msg4 are mainly intended for specifying for the terminal device a unique and legal identity (ID), i. e. a C-RNTI, in order for subsequent data transmission.

Step III, transmit Msg3.

The Msg3 is transmitted on a physical uplink shared channel (PUSCH). The Msg3 needs to contain important information, that is, a unique ID of each terminal device. The ID can be used for contention resolution in step IV. For the terminal device in an RRC_CONNECTED state, the unique ID of the terminal device is a C-RNTI. For the terminal device in a non-RRC_CONNECTED state, a unique terminal-device ID (a serving-temporary mobile subscriber identity (S-TMSI) or a random number) from a core network is used as the ID.

Step IV, transmit Msg4.

The terminal device carries its unique ID, i. e. the terminal-device ID from the core network or the C-RNTI, in the Msg3. In the contention resolution mechanism, the network device will carry a unique ID in the Msg4 to indicate a terminal device that succeeds, while other terminal devices that failed in the contention resolution will initiate random access again. If a PDSCH received by the terminal device in the Msg4 is scrambled by a TC-RNTI specified in the RAR, when a UE contention resolution identity MAC-control element (MAC CE) in a successfully decoded MAC protocol data unit (PDU) matches a common control channel-service data unit (CCCH SDU) transmitted in the Msg3, the terminal device considers that the random access is successful and sets the C-RNTI according to its own TC-RNTI.

### (2) Contention-Based 2-Step Random Access Procedure

In release 16 (R16), in order to reduce access delay of the terminal device, a contention-based 2-step random access procedure is introduced. As illustrated in FIG. 7, the contention-based 2-step random access procedure mainly includes the following two steps.

Step I, transmit message A (MsgA).

The random access request message is MsgA.

The MsgA can include a PRACH preamble (namely, the Msg1 in the foregoing step I) and uplink data (namely, the Msg3 in the foregoing step III). The PRACH preamble can also be referred to as a MsgA PRACH. The uplink data can also be referred to as a MsgA PUSCH or a MsgA PUSCH payload.

For MsgA PRACH transmission, an RO is introduced in the protocol standard. For example, the network device configures an RO via higher-layer signaling (such as system information), where the RO is used for transmitting (or carrying) a MsgA PRACH, and there is a mapping (association/correspondence, etc.) between ROs and synchronization signal and physical broadcast channel (PBCH) blocks (SSB).

For MsgA PUSCH transmission, a PUSCH occasion (PO) is introduced in the protocol standard. For example, the network device configures a PO via higher-layer signaling (such as system information), where the PO is used for transmitting (or carrying) a MsgA PUSCH, and there is a mapping (association/correspondence) between POs and de-modulation reference signal (DMRS) resources. The DMRS resource can be configured via a higher-layer parameter (such as msgA-DMRS-Configuration).

Step II, transmit message B (MsgB).

The RAR message is MsgB.

The MsgB includes the Msg2 in the foregoing step II and the Msg4 in the foregoing step IV.

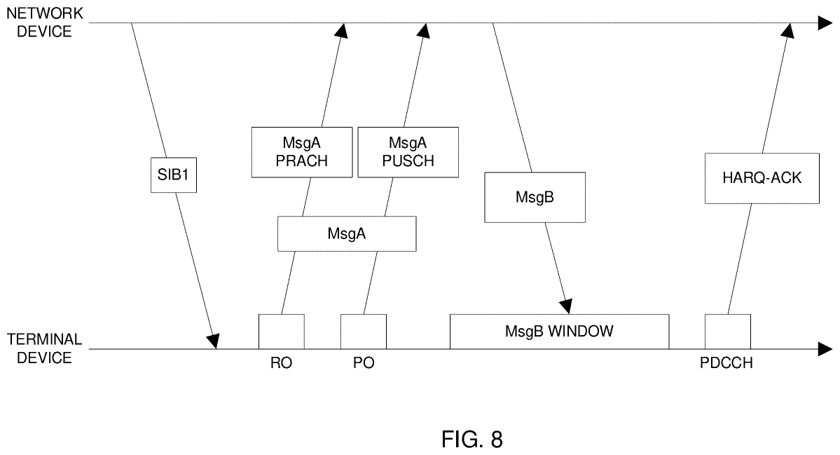

After the MsgA sent by the terminal device is successfully detected, the network device carries a success RAR (successRAR) in the MsgB. The successRAR can indicate to the terminal device a physical uplink control channel (PUCCH) resource used for transmitting hybrid automatic repeat request-acknowledgement (HARQ-ACK) feedback information corresponding to the MsgB, where the PUCCH resource includes a PUCCH time-frequency resource, as illustrated in FIG. 8.

It should be noted that, the terminal device receives the MsgB, and needs to feed back to the network device whether the MsgB is correctly decoded. Therefore, the terminal device can perform feedback via the HARQ-ACK feedback information corresponding to the MsgB.

### (3) PRACH Preamble

### 1) Structure, Classification, and Number of PRACH Preambles

The PRACH preamble can consist of a cyclic prefix (CP) and a sequence.

The PRACH preamble supports four long sequences with a length of 839 and nine short sequences with a length of 139, and the length of the sequence constituting the PRACH preamble can be indicated by a higher-layer parameter prach-RootSequenceIndex.

There can be 64 PRACH preambles available for each cell, and the 64 PRACH preambles constitute a PRACH preamble sequence, where each PRACH preamble has a unique index (PRACH preamble index) in the PRACH preamble sequence. The terminal device selects (or the network device indicates) one PRACH preamble from the PRACH preamble sequence in order for transmission in an RO, that is, the PRACH preamble is carried (or transmitted) in the RO.

The PRACH preamble sequence can include the following: a contention-based (CB) random access preamble (CBPRACH preamble) sequence and a contention-free (CF) random access preamble (CFPRACH preamble) sequence indicated by a higher-layer parameter totalNumberOfRA-Preambles; and a PRACH preamble sequence other than that indicated by the higher-layer parameter totalNumberOfRA-Preambles, and a PRACH preamble in such PRACH preamble sequence is for other uses, such as system information (SI) request.

It should be noted that, if the number of PRACH preambles is not configured via the higher-layer parameter totalNumberOfRA-Preambles, all of the 64 PRACH preambles are used for contention-based random access and contention-free random access.

In addition, the CBPRACH preamble can be classified into two groups: group A and group B. Group B does not necessarily exist, and can be configured via a higher-layer parameter ssb-perRACH-OccasionAndCB-PreamblesPerSSB.

The network device can configure a parameter for contention-based random access via a higher-layer parameter RACH-ConfigCommon (carried in bandwidth part-common (BWP-Common) in system information block 1 (SIB1)). The network device can configure a parameter for contention-free random access via a higher-layer parameter RACH-ConfigDedicated.

### (4) PRACH Time-Frequency Resource

During random access, a PRACH time-frequency resource is needed for transmission of the Msg1 or the MsgA PRACH, where the PRACH time-frequency resource can include at least one RO, and the RO can be divided into a time-domain RO and a frequency-domain RO.

The time-domain RO (namely, a PRACH time-domain resource for transmitting/carrying RA preamble/Msg1, or a time-domain location of the RO) can be configured via a parameter prach-ConfigurationIndex in a higher-layer parameter RACH-ConfigGeneric, as illustrated in Table 1.

Table 1 defines random access configurations for frequency range 1 (FR1) and paired spectrum/supplementary uplink, where n_{f} represents a system frame number, x represents a PRACH configuration period, and Nₜ^{RA,slot} represents the number of ROs within a PRACH slot, and N_{dur}^{RA} represents a PRACH duration.

TABLE 1

| | | | | | | | Nₜ^{RA, slot}, | |
|---|---|---|---|---|---|---|---|---|
| | | | | | | | number | |
| | | | | | | | of time- | |
| | | | | | | Number of | domain | |
| PRACH | | n_{f} mod | | | | PRACH | ROs within | N_{dur}^{RA}, |
| configuration | Preamble | x = y | | Subframe | Starting | slots within | a PRACH | PRACH |
| index | format | x | y | number | symbol | a subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| 11 | 0 | 4 | 1 | 9 | 0 | — | — | 0 |
| 12 | 0 | 2 | 1 | 1 | 0 | — | — | 0 |
| 13 | 0 | 2 | 1 | 4 | 0 | — | — | 0 |
| 14 | 0 | 2 | 1 | 7 | 0 | — | — | 0 |
| 15 | 0 | 2 | 1 | 9 | 0 | — | — | 0 |
| 16 | 0 | 1 | 0 | 1 | 0 | — | — | 0 |
| 17 | 0 | 1 | 0 | 4 | 0 | — | — | 0 |
| 18 | 0 | 1 | 0 | 7 | 0 | — | — | 0 |
| 19 | 0 | 1 | 0 | 1, 6 | 0 | — | — | 0 |
| 20 | 0 | 1 | 0 | 2, 7 | 0 | — | — | 0 |
| . . . | . . . | . . . | . . . | . . . | . . . | . . . | . . . | . . . |
| 109 | A1/B1 | 2 | 0 | 4 | 0 | 2 | 7 | 7 |
| . . . | . . . | . . . | . . . | . . . | . . . | . . . | . . . | . . . |

For example, when the PRACH configuration index is 109, the random access preamble format is A1/B1; every two system frames (namely, 0, 2, 4 . . . ) have a time-domain RO (namely, n_{f} mod 2=0); a starting location of a time-domain RO in a 9^{th} subframe in a system frame starts from a 0^{th} orthogonal frequency division multiplexing (OFDM) symbol; there are two PRACH slots within the 9^{th} subframe, and there are seven (Nₜ^{RA,slot}=7) time-domain ROs per PRACH slot; and the PRACH duration is 7 (N_{dur}^{RA}=7), that is, the PRACH occupies 7 OFDM symbols.

The frequency-domain RO (namely, a PRACH frequency-domain resource for transmitting/carrying the PRACH preamble, or a frequency-domain location of the RO) can be configured via parameters msg1-FrequencyStart and msg1-FDM in a higher-layer parameter RACH-ConfigGeneric.

The parameter msg1-FrequencyStart can be used to configure an offset from a starting frequency-domain location of the RO to a starting frequency-domain location of an initial BWP or an active BWP. The parameter msg1-FDM can be used to configure the number of frequency-domain ROs per time-domain RO.

### (5) PUSCH Time-Frequency Resource

During random access, a PUSCH time-frequency resource is needed for transmission of the MsgA PUSCH, where the PUSCH time-frequency resource can include at least one PO, and the PO can be divided into a time-domain PO and a frequency-domain PO.

In time domain, the PO includes a PUSCH resource period, a slot location of a PUSCH resource, the number of POs per PUSCH slot, a location of a symbol occupied by each PO, etc.

In frequency domain, the PO includes a starting resource block (RB) index of a 1^{st} frequency-domain PO, a size (namely, the number of RBs occupied) of a frequency-domain PO, and the number of frequency-domain POs.

Different POs can also be differentiated according to DMRS sequences or DMRS ports, that is, each PO can be differentiated by a DMRS sequence or a DMRS antenna port, in other words, the same PO can be associated with different DMRS resources, and can constitute different PUSCH resource units (PRU).

There is a mapping between PRACH preambles and POs. Generally, one or more PRACH preambles are mapped to one PO.

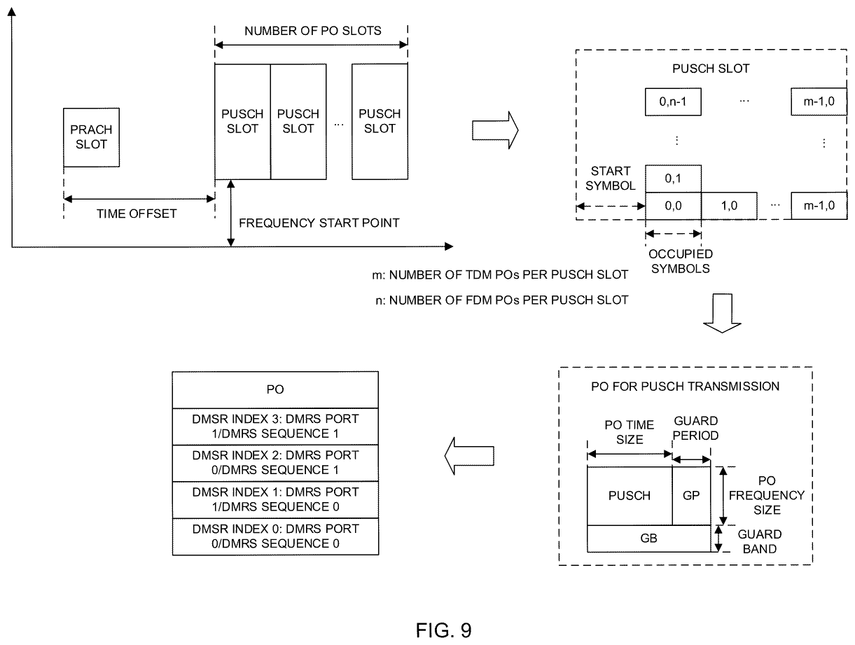

PO configuration is illustrated in FIG. 9.

(6) Beam Corresponding to (Mapped to/Associated with) SSB

In a 5^{th}-generation (5G) NR communication system, with increase in frequency of a cell, a coverage range of the cell decreases. In order to increase the coverage range of the cell, some broadcast information can be sent by means of beam sweeping rather than coverage.

In beam sweeping, energy is concentrated into a certain direction at a certain time, and as such, a signal can be sent farther in this direction but cannot be received in other directions. At the next time, the signal is sent in another direction. By consistently changing the beam direction, coverage of the whole cell can be achieved.

In NR 5G, the beam is used in a random access procedure. An SSB has multiple transmission opportunities within a time-domain period and has a corresponding index, i. e. an SSB index.

Each beam can correspond to (be mapped to/associated with) at least one SSB, and beams corresponding to different SSB indexes can be the same (in the same direction) or different (in different directions).

The SSB is in the unit of 5-millisecond (ms) half frame, that is, an SS burst set, and all SSBs in the SS burst set need to be transmitted in the same half frame periodically. The SSB occurs several times within a certain half frame at a time interval, where each of the several SSBs corresponds to one beam-sweeping direction, and as such, there is one SSB in each direction.

For the terminal device, the terminal device has an opportunity to send a PRACH preamble, that is, a PRACH preamble corresponding to (associated with/mapped to) the beam, only when the beam-sweeping signal for the SSB covers the terminal device. In this case, when the PRACH preamble from the terminal device is received by the network device, the network device can know the optimal downlink beam, that is, the network device knows which beam is directed to the terminal device.

Since the beam corresponds to the PRACH preamble and also corresponds to the SSB, the SSB needs to correspond to (be associated with/mapped to) the PRACH preamble. In addition, since the PRACH preamble can be sent only in an RO, that is, the PRACH preamble needs to be carried (or transmitted) in the RO, the SSB needs to be associated with (be mapped to/correspond to) the RO, so that the network device knows which beam is to be used for sending the Msg2 to the terminal device.

(7) SSB Associated with (Mapped to/Corresponding to) RO and PRACH Preamble

The higher layer can configure, via a higher-layer parameter ssb-perRACH-OccasionAndCB-PreamblesPerSSB, N SSBs associated with (mapped to/corresponding to) one RO (configured via a layer 1 (L1) parameter SSB-per-rach-occasion) and R PRACH preambles with consecutive indexes associated with (mapped to/corresponding to) each of the N SSBs (configured via an L1 parameter CB-preambles-per-SSB).

The value of N can be {⅛, ¼, ½, 1, 2, 4, 8, 16}.

The configurations of N include the following two cases.

If N<1, one SSB can be associated with 1/N consecutive valid ROs, and R CBPRACH preambles with consecutive indexes are mapped to SSB n, where 0<=n<=N−1. The CBPRACH preamble sequence associated with the SSB starts from PRACH preamble index 0.

For example, if N=⅛, one SSB is associated with 8 ROs, and the SSB is associated with 8 preambles starting from index 0.

If N>=1, N SSBs can be associated with one RO, and R CBPRACH preambles with consecutive indexes are mapped to SSB n, where 0<=n<=N−1, and n represents the SSB index. The CBPRACH preamble sequence associated with SSB n starts from PRACH preamble index n* N_{preamble}^{total}/N, where N_{preamble}^{total} is configured via a higher-layer parameter totalNumberOfRA-Preambles and is an integer multiple of N.

For example, if N=2 and N_{preamble}^{total}=64, two SSBs are associated with one RO, the PRACH preambles associated with SSB 0 start from index 0, and the PRACH preambles associated with SSB 1 start from index 32. That is, SSB 0 is associated with PRACH preambles with indexes of 0˜31, and SSB 1 is associated with PRACH preambles with indexes of 32˜ (the total number of corresponding PRACH preambles−1).

For link recovery, N SSBs associated with one RO are indicated to the terminal device via a parameter ssb-perRACH-Occasion carried in a higher-layer parameter BeamFailureRecoveryConfig. If N<1, one SSB is associated with 1/N consecutive valid ROs; if N>=1, N SSBs are associated with one RO.

In conclusion, the mapping between SSBs and ROs can follow the following principles: first, in increasing order of PRACH preamble indexes within a single RO; second, in increasing order of frequency resource indexes for frequency multiplexed ROs (also referred to as frequency-domain ROs); third, in increasing order of time resource indexes for time multiplexed ROs (also referred to as time-domain ROs) within a PRACH slot; finally, in increasing order of indexes for PRACH slots.

(8) Channel State Information-Reference Signal (CSI-RS) Associated with (or Mapped to) RO

Like the SSB, there is a correspondence between CSI-RS IDs and beams. If a random access procedure is triggered upon request by higher layers and a CSI-RS index is associated with an RO, when a parameter ra-PreambleIndex is not 0, a parameter ra-OccasionList indicates a list of ROs associated with the CSI-RS index.

### (9) Msg1 Transmission

In a random access procedure, the terminal device can transmit (carry) the Msg1 in an RO. The random access procedure is triggered in the following three modes.

Triggered by a PDCCH order: in a special DCI format 1_0, the network device notifies to the terminal device that the terminal device needs initiate the random access procedure again, and notifies to the terminal device ra-PreambleIndex, an SSB index, and a PRACH mask index that are to be used, as well as an uplink/supplementary uplink (UL/SUL) indicator indicating whether UL or SUL is to be used.

Triggered by a MAC layer: the UE autonomously selects a PRACH preamble to initiate a random access procedure.

Triggered by an RRC layer: such as initial access, re-establishment, handover, transition to an RRC_CONNECTED state from RRC_INACTIVE, request for other SI, RRC request upon synchronous reconfiguration, etc.

When the terminal device is to transmit the Msg1, the terminal device needs to perform the following operations.

### 1) Selection of SSB or CSI-RS

It should be noted that, the RO contains a PRACH preamble index, where there is an association (mapping/correspondence) between value ranges of the PRACH preamble index and SSB indexes or CSI-RS indexes, and there is a mapping between SSB indexes or the CSI-RS indexes and ROs.

### 1. Selection of SSB

The SSB can be used in either a contention-based random access procedure or a contention-free random access procedure. When selecting an SSB, the terminal device can select according to different event-trigger scenarios, which is specifically as follows.

a. Contention-Free Random Access Procedure

With regard to a contention-free random access procedure triggered by beam failure and other events (except for triggered by a PRACH order and triggered by an SI request), the terminal device can obtain synchronization signal-reference signal received powers (SS-RSRP) of SSBs through channel estimation, and then compare the SS-RSRPs of the SSBs with a parameter rsrp-ThresholdSSB. If there is one SSB whose SS-RSRP is greater than the rsrp-ThresholdSSB, the terminal device selects the SSB.

For a contention-free random access procedure triggered by a PDCCH order, the terminal device directly selects an SSB indicated by the PDCCH order.

For a contention-free random access procedure triggered by an SI request, if there is one SSB whose SS-RSRP is greater than the parameter rsrp-ThresholdSSB, the terminal device selects the SSB; otherwise, the terminal device selects one SSB randomly. If there are multiple SSBs whose SS-RSRP is greater than the rsrp-ThresholdSSB, the terminal device selects one SSB randomly from the multiple SSBs.

b. Contention-Based Random Access Procedure

If there is one SSB whose SS-RSRP is greater than the parameter rsrp-ThresholdSSB, the terminal device selects the SSB; otherwise, the terminal device selects one SSB randomly. If there are multiple SSBs whose SS-RSRP is greater than the rsrp-ThresholdSSB, the terminal device selects one SSB randomly from the multiple SSBs.

### 2. Selection of CSI-RS

The CSI-RS can be used in either a contention-free random access procedure (except for triggered by a PDCCH order and triggered by an SI request) or a contention based random access procedure. When selecting a CSI-RS, CSI-RSRPs of CSI-RSs are compared with the parameter rsrp-ThresholdCSI-RS. If there is one CSI-RS whose CSI-RSRP is greater than the parameter rsrp-ThresholdCSI-RS, the terminal device selects the CSI-RS.

### 2) Selection of PRACH Preamble Index

### 1. Contention-Based Random Access Procedure

The PRACH preamble index is selected by the terminal device. The terminal device needs to determine whether to select the PRACH preamble from group A or from group B. If group B exists, whether to select from group B needs to be determined according to a related configuration parameter; otherwise, the terminal device selects from group A.

If the terminal device has transmitted the Msg3 but access failed, a PRACH preamble used for the terminal device to attempt access again shall belong to the same group as a PRACH preamble that was used for the 1^{st} transmission of the Msg3.

After determining the group, the terminal device selects one PRACH preamble randomly from PRACH preambles associated with the selected SSB in the group.

### 2. Contention-Free Random Access Procedure

The PRACH preamble index is indicated by the network device. The network device can allocate the PRACH preamble index in the following two modes.

In a first mode, the PRACH preamble index is configured via a ra-PreambleIndex field in a higher-layer parameter PRACH-ConfigDedicated.

In a second mode, in random access triggered by a PDCCH order, the PRACH preamble index is configured via a random access preamble index field in a DCI format 1-0.

### 3) Selection of PRACH Resource for Carrying (Transmitting) PRACH Preamble

For a contention-free random access procedure, a higher-layer parameter PRACH mask index can be used to determine a location of the PRACH resource for the contention-free random access procedure.

For a contention-based random access procedure, after the terminal device is ready for the Msg1, the terminal device determines a next available RO from ROs associated with the SSB as a location of a next available PRACH resource. For a contention-free random access procedure, after the UE is ready for the Msg1, the location of the next available PRACH resource is determined according to the PRACH mask index.

There are four modes for configuring a contention-free PRACH mask index: the contention-free PRACH mask index is indicated by a parameter ra-ssb-OccasionMaskIndex in a higher-layer parameter PRACH-ConfigDedicated; the contention-free PRACH mask index is indicated by a parameter ra-ssb-OccassionMakIndex in a higher-layer parameter BeamFailureRecoveryConfig; the contention-free PRACH mask index is indicated by a parameter ra-ssb-OccassionMakIndex in a parameter SI-RequestResources in a higher-layer parameter SI-SchedulingInfo in SIB1; the contention-free PRACH mask index is indicated by a PDCCH order via a PRACH mask index in a DCI format 1-0.

### 4) Determination of Corresponding RA-RNTI

An RA-RNTI value depends on a time-domain location of a PRACH resource. After transmitting the PRACH preamble, the terminal device calculates an RA-RNTI associated with the RO so as to receive an RAR scrambled by the RA-RNTI. The formula for calculating the RA-RNTI is as follows (except for a contention-free random access preamble used for a beam failure recovery request):

$$RA - RNTI = 1 + s\_id + 14 \times t\_id + 14 \times 80 \times f\_id + 14 \times 80 \times 8 \times ul\_carrier \_id$$

s_id (0≤s_id<14) is an index of a 1^{st} OFDM symbol of the RO. t_id (0≤t_id<80) is an index of a 1^{st} slot for the RO in a system frame. f_id (0≤f_id<8) is an index of the RO in frequency domain. ul_carrier_id is an UL carrier for PRACH preamble transmission (0 represents a normal UL carrier, and 1 represents an SUL carrier).

### 5) Determination of Target Received Power of PRACH Preamble

### (10) MsgA Transmission

In MsgA transmission in 2-step random access, MsgA includes a MsgA PRACH and a MsgA PUSCH. A PRACH preamble is transmitted (or carried) in an RO, and a MsgA PUSCH is transmitted (or carried) in a PO.

In order to distinguish 2-step random access from 4-step random access, the following two modes can be used.

Mode 1: an RO can be shared between 2-step random access and 4-step random access, but it is necessary to use different PRACH preambles.

Mode 2: use different ROs for 2-step random access and 4-step random access.

Regarding the mode of sharing the RO, all ROs or a subset of the ROs for 4-step random access can be shared with 2-step random access.

Regarding the mode of using different ROs, an RO used for 2-step random access and an RO used for 4-step random access have different indexes in time domain.

A CBPRACH preamble for 2-step random access corresponding to the SSB is configured via a higher-layer parameter msgA-CB-PreamblesPerSSB-PerSharedRO.

A location of a sequence in which the CBPRACH preamble for 2-step random access is located is adjacent to a location of a sequence in which a CFPRACH preamble is located.

A starting index of the CBPRACH preamble(s) for 2-step random access corresponding to the SSB is configured via a higher-layer parameter end of the 4-step CBPRACH preambles for that SSB.

MsgA transmission includes the following steps: obtain resource configuration of an RO and resource configuration of a PO according to system information; select an SSB index, and determine an RO/PRACH preamble corresponding to (associated with/mapped to) the SSB index; determine a PO/DMRS resources corresponding to the RO/PRACH preamble; and perform MsgA transmission by using the RO/PRACH preamble and the PO/DMRS resource.

### IV. Communication Method

In order to realize uplink coverage enhancement in a 2-step random access procedure, in embodiments of the disclosure, MsgA and hybrid automatic repeat request-acknowledgement (HARQ-ACK) feedback information corresponding to MsgB are transmitted by means of repetitions.

In order to realize repetitions of the MsgA, in embodiments of the disclosure, it is necessary to design a channel structure of the MsgA and introduce a repetition number of MsgA PRACH and a repetition number of MsgA PUSCH. The design of the channel structure of the MsgA can include a transmission resource (such as an RO set) for repetitions of MsgA PRACH, a transmission resource (such as a PO set) for repetitions of MsgA PUSCH, and a mapping rate between PRACH preambles, POs, and DMRS resources.

Likewise, in order to realize repetitions of the HARQ-ACK feedback information corresponding to the MsgB, in embodiments of the disclosure, a repetition number of PUCCH for transmitting the HARQ-ACK feedback information corresponding to the MsgB is introduced.

In order to implement the foregoing technical solutions, other contents, concepts, and meanings related thereto are further illustrated below.

### (1) Design of Channel Structure of MsgA, the Repetition Number of MsgA PRACH, and the Repetition Number of MsgA PUSCH

It should be noted that, the design of the channel structure of the MsgA can include the transmission resource for repetitions of MsgA PRACH, the transmission resource for repetitions of MsgA PUSCH, the mapping rate between PRACH preambles, POs, and DMRS resources, etc., which will be described in detail below.

### 1) The Repetition Number of MsgA PRACH

It should be noted that, the repetition number of MsgA PRACH can represent the number of MsgA PRACH transmissions performed by means of repetitions, where the MsgA PRACH can also be understood as a PRACH preamble or Msg1 in a 4-step random access procedure.

In some possible implementations, the repetition number of MsgA PRACH can be determined through network configuration or pre-configuration.

It should be noted that, network configuration can be understood configuration by a network device via a higher-layer parameter/higher-layer signaling/system information/terminal device-specific signaling during cell search, cell re-selection, uplink and downlink synchronization, cell access, cell camping, initial access, uplink and downlink resource scheduling, and the like.

For example, the network device configures for a terminal device a value of the repetition number of MsgA PRACH as 2 via system information.

Pre-configuration can be understood as pre-configured at the terminal device.

For example, the value of the repetition number of MsgA PRACH pre-configured at the terminal device is 2.

### 2) The Repetition Number of MsgA PUSCH, First Repetition Number of MsgA PUSCH, and Second Repetition Number of MsgA PUSCH

The repetition number of MsgA PUSCH can represent the number of MsgA PUSCH transmissions performed by means of repetitions, where the MsgA PUSCH can include a PUSCH payload.

In some possible implementations, the repetition number of MsgA PUSCH can be one value among at least one candidate value of the repetition number of MsgA PUSCH.

It should be noted that, the repetition number of MsgA PUSCH corresponding to the maximum value among the at least one candidate value of the repetition number of MsgA PUSCH can be referred to as the “second repetition number of MsgA PUSCH”.

In addition, the “second repetition number of MsgA PUSCH” can also be described in other terms, which shall all belong to the protection scope of the disclosure as long as they have the same meaning/function/concept, etc.

In some possible implementations, the at least one candidate value of the repetition number of MsgA PUSCH can be implemented in the following modes.

### Mode I: Network Configuration or Pre-Configuration

It should be noted that, the meaning of “network configuration” or “pre-configuration” is similar to that described above.

In actual implementation, the network device can configure the at least one candidate value of the repetition number of MsgA PUSCH for the terminal device via higher-layer signaling, so that the terminal device can determine the repetition number of MsgA PUSCH from the at least one candidate value of the repetition number of MsgA PUSCH. Alternatively, the at least one candidate value of the repetition number of MsgA PUSCH is pre-configured at the terminal device, so that the terminal device can determine the repetition number of MsgA PUSCH from the at least one candidate value of the repetition number of MsgA PUSCH.

For example, the network device configures for the terminal device the candidate value of the repetition number of MsgA PUSCH as {2, 4, 6} via system information.

In addition, the repetition numbers of MsgA PUSCH configured for different terminal devices by the network device can be different.

In some possible implementations, the terminal device can determine the repetition number of MsgA PUSCH (namely, the first repetition number of MsgA PUSCH) from the at least one candidate value of the repetition number of MsgA PUSCH to send a MsgA PUSCH payload, which can be implemented as follows.

### Mode 1: Determination According to a Signal Measurement Result of a Serving Cell

It should be noted that, the terminal device can determine the repetition number of MsgA PUSCH from the at least one candidate value of the repetition number of MsgA PUSCH according to a signal-quality measurement result of a reference signal from the serving cell.

For example, the signal quality of the reference signal can be represented by one or more of the following parameters: a channel quality measurement parameter (such as a signal to interference plus noise ratio (SINR)), a reference signal received power (RSRP), a reference signal received quality (RSRQ), or a received signal strength indication (RSSI).

Mode 2: Determination According to Satellite Ephemeris Information and/or Satellite Navigation Information

It should be noted that, in an NTN communication system, the terminal device can determine, according to the satellite ephemeris information and/or the satellite navigation information, the repetition number of MsgA PUSCH from the at least one candidate value of the repetition number of MsgA PUSCH.

The satellite ephemeris information can be moving orbit information of a satellite, or a location and velocity information of the satellite at a certain time. Therefore, in embodiments of the disclosure, the UE can calculate the location of the satellite at any time according to the satellite ephemeris information.

The satellite navigation information can be information obtained from a global navigation satellite system (GNSS), such as a global positioning system (GPS), a BeiDou navigation satellite system (BDS), or the like.

It should be noted that, in the above “mode I”, the repetition number of MsgA PUSCH is determined through network configuration or pre-configuration. In “mode 1” and “mode 2”, the repetition number of MsgA PUSCH is determined by the terminal device autonomously.

In addition, the repetition number of MsgA PUSCH determined in “mode 1” or “mode 2” can be referred to as the “first repetition number of MsgA PUSCH”.

Further, the “first repetition number of MsgA PUSCH” can also be described in other terms, which shall all belong to the protection scope of the disclosure as long as they have the same meaning/function/concept, etc.

### Mode II: Determination According to a Correspondence (Mapping/Association, etc.) Between the Repetition Numbers of MsgA PRACH and the Repetition Numbers of MsgA PUSCH

It should be noted that, the correspondence between the repetition numbers of MsgA PRACH and the repetition numbers of MsgA PUSCH can be configured by the network or pre-configured.

In some possible implementations, in the correspondence, each value of the repetition number of MsgA PRACH can correspond to at least one candidate value of the repetition number of MsgA PUSCH.

Exemplarily, the correspondence between the repetition numbers of MsgA PRACH and the repetition numbers of MsgA PUSCH is illustrated in Table 2.

TABLE 2

| Repetition number of | Repetition number of |
|---|---|
| MsgA PRACH | MsgA PUSCH |
| 1 | 2, 4 |
| 2 | 4, 6 |
| 4 | 6, 8 |
| 8 | 12, 16 |
| . . . | . . . |

When the value of the repetition number of MsgA PRACH is 1, the candidate value of the repetition number of MsgA PUSCH is {2, 4}; when the value of the repetition number of MsgA PRACH is 2, the candidate value of the repetition number of MsgA PUSCH is {4, 6}; and so forth.

“Mode II” will be exemplified below with reference to Table 2.

For example, the network device firstly configures for the terminal device the correspondence between the repetition numbers of MsgA PRACH and the repetition numbers of MsgA PUSCH illustrated in Table 2 via higher-layer signaling, and then configures for the terminal device the value of the repetition number of MsgA PRACH as 4 via system information.

In this way, the terminal device can determine, according to the value of the repetition number of MsgA PRACH and the correspondence, that the candidate value of the repetition number of MsgA PUSCH is {6, 8}.

In some possible implementations, the terminal device can determine the repetition number of MsgA PUSCH (namely, the first repetition number of MsgA PUSCH) from the at least one candidate value of the repetition number of MsgA PUSCH to send a MsgA PUSCH payload as follows: determine according to the signal measurement result of the serving cell; or determine according to the satellite ephemeris information and/or the satellite navigation information.

It should be noted that, the details thereof are similar to those in the foregoing “mode 1” and “mode 2”, which are not described again herein.

### 3) PO Set

As can be seen from the foregoing “(5) PUSCH time-frequency resource”, for MsgA PUSCH transmission, a PO is introduced in the protocol standard, where the PO is used for transmitting (or carrying) a MsgA PUSCH, and there is a mapping (association/correspondence) between POs and DMRS resources.

In order to implement MsgA repetitions of according to the repetition number of MsgA PUSCH, in embodiments of the disclosure, POs in a PUSCH time-frequency resource need to be grouped to obtain a PO set(s).

### 1. The Number (R, Where R is a Positive Integer) of POs in PO Set

In some possible implementations, the number of POs in a PO set can be as follows.

Mode a: the number of POs in the PO set is the maximum value among the at least one candidate value of the repetition number of MsgA PUSCH.

In actual implementation, in the foregoing “mode I”, after determining the at least one candidate value of the repetition number of MsgA PUSCH, the terminal device can perform PO grouping according to the maximum value (R, where R is a positive integer) among the at least one candidate value of the repetition number of MsgA PUSCH, so as to obtain a PO set. The PO set includes R POs, that is, the number of POs in the PO set is the maximum value among the at least one candidate value of the repetition number of MsgA PUSCH.

For example, the network device configures for the terminal device the candidate value of the repetition number of MsgA PUSCH as {2, 4, 6} via system information. In this way, the terminal device can perform PO grouping according to the maximum value among {2, 4, 6} (namely, R=6). When grouping, R POs can constitute one PO set.

Likewise, in the foregoing “mode II”, after determining the at least one candidate value of the repetition number of MsgA PUSCH, the terminal device can perform PO grouping according to the maximum value (namely, R) among the at least one candidate value of the repetition number of MsgA PUSCH, so as to obtain a PO set, where the PO set includes R POs.

For example, the network device firstly configures for the terminal device the correspondence between the repetition numbers of MsgA PRACH and the repetition numbers of MsgA PUSCH illustrated in Table 2 via higher-layer signaling, and then configures for the terminal device the value of the repetition number of MsgA PRACH as 2 via system information. In this way, the terminal device can determine, according to Table 2, that the candidate value of the repetition number of MsgA PUSCH is {4, 6}, and perform PO grouping according to the maximum value among {4, 6} (namely, R=6). When grouping, R POs can constitute one PO set.

Mode b: the number of POs in a PO set is configured by the network or pre-configured.

For example, the network device configures directly the number of POs in the PO set via higher-layer signaling, i. e., the network indicates directly the number of POs in the PO set.

### 2. R POs in PO Set

In some possible implementations, the R POs in the PO set can be R POs that are consecutive in time domain.

It can be understood that, R POs that are consecutive in time domain are one PO set.

In some possible implementations, each of the R POs in the PO set corresponds to a same DMRS resource.

It can be understood that, the PO corresponds to a DMRS resource, and each PO in the PO set corresponds to the same DMRS resource.

In some possible implementations, each of the R POs in the PO set corresponds to a same number of DMRS resources.

It can be understood that, each PO in the PO set corresponds to the same number of DMRS resources.

### 4) RO Set

As can be seen from the foregoing “(4) PRACH time-frequency resource”, for MsgA PRACH transmission, an RO is introduced in the protocol standard, where the RO is used for transmitting (or carrying) a MsgA PRACH, and there is a mapping (association/correspondence) between ROs and PRACH preambles.

In order to implement MsgA repetitions according to the repetition number of MsgA PRACH, in embodiments of the disclosure, ROs in a PRACH time-frequency resource need to be grouped to obtain an RO set(s).

1. The number (K, Where K is a Positive Integer) of ROs in an RO Set

In actual implementation, after determining a value (namely, K, where K is a positive integer) of the repetition number of MsgA PRACH, the terminal device can perform RO grouping according to the value of the repetition number of MsgA PRACH to obtain an RO set, where the RO set includes K ROs.

For example, the network device configures for the terminal device the value of the repetition number of MsgA PRACH as 2 (namely, K=2) via system information. In this way, the terminal device can perform RO grouping according to K. When grouping, K ROs can constitute one RO set.

In some possible implementations, there can be a correspondence (mapping/association, etc.) between RO sets and SSBs, where the correspondence between RO sets and SSBs can be configured by the network or pre-configured.

### 2. K ROs in RO Set

In some possible implementations, the K ROs in the RO set can be K ROs that are consecutive in time domain.

It can be understood that, the K ROs that are consecutive in time domain is one RO set.

In some possible implementations, each of the K ROs in the RO set can correspond to a same PRACH preamble.

It can be understood that, the RO corresponds to a PRACH preamble, and each RO in the RO set corresponds to the same PRACH preamble.

In some possible implementations, each of the K ROs in the RO set can correspond to a same number of PRACH preambles.

It can be understood that, each RO in the RO set corresponds to the same number of PRACH preambles.

### 5) DMRS Resource and DMRS Resource Set

In embodiments of the disclosure, each DMRS resource (DMRS resource index) corresponds to one DMRS sequence and one DMRS port.

In some possible implementations, there is a correspondence (mapping/association, etc.) between DMRS resources (DMRS resource indexes) and the repetition numbers of MsgA PUSCH. The correspondence can be configured by the network or pre-configured.

It should be noted that, the terminal device or the network device can determine the repetition number of MsgA PUSCH corresponding to the DMRS resource (DMRS resource index) according to the correspondence.

In addition, in the correspondence, each repetition number (that is, quantity) of MsgA PUSCH can correspond to at least one DMRS resource index, and different repetition numbers of MsgA PUSCH can correspond to different DMRS resource indexes.

For example, the correspondence between DMRS resource indexes and the repetition numbers of MsgA PUSCH is illustrated in Table 3.

TABLE 3

| DMRS resource index | Repetition number of MsgA PUSCH |
|---|---|
| 0, 1 | 2 |
| 2, 3 | 4 |
| . . . | . . . |

When a value of the repetition number of MsgA PUSCH is 2, a candidate value of the DMRS resource index is {0, 1}; when the value of the repetition number of MsgA PUSCH is 4, the candidate value of the DMRS resource index is {2, 3}; and so forth.

In addition, in embodiments of the disclosure, DMRS resources can be grouped, i. e. a DMRS resource set(s). In this way, there is a correspondence (mapping/association, etc.) between DMRS resource sets and the repetition numbers of MsgA PUSCH.

In some possible implementations, different DMRS resources (DMRS resource indexes) in the same DMRS resource set correspond to different repetition numbers of MsgA PUSCH.

For example, with reference to the above Table 3, in embodiments of the disclosure, a DMRS resource with an index of 0 (namely, DMRS 0) and a DMRS resource with an index of 2 (namely, DMRS 2) can constitute one set so as to obtain {DMRS 0, DMRS 2}, where the repetition number of MsgA PUSCH corresponding to DMRS 0 is 2, and the repetition number of MsgA PUSCH corresponding to DMRS 2 is 4.

Likewise, a DMRS resource with an index of 1 (namely, DMRS 1) and a DMRS resource with an index of 3 (namely, DMRS 3) constitute one set so as to obtain {DMRS 1, DMRS 3}, where the repetition number of MsgA PUSCH corresponding to DMRS 1 is 2, and the repetition number of MsgA PUSCH corresponding to DMR 3 is 4.

### (6) MsgA PUSCH Resource and MsgA PUSCH Resource Set

It should be noted that, the MsgA PUSCH resource can be understood as a resource for transmitting (or carrying) a MsgA PUSCH.

Each MsgA PUSCH resource can correspond to one PO and one DMRS resource. Therefore, in embodiments of the disclosure, the MsgA PUSCH can be transmitted by using the PO and the DMRS resource.

Since the “PO set” is introduced in embodiments of the disclosure, with reference to the concept of “PO set”, the concept of “MsgA PUSCH resource set” is also introduced in embodiments of the disclosure. The MsgA PUSCH resource set can be understood as resources for repetitions of MsgA PUSCH.

In actual implementation, each MsgA PUSCH resource set can correspond to R POs in time domain and one DMRS resource or one DMRS resource set.

That is, each MsgA PUSCH resource set can correspond to one PO set and one DMRS resource or one DMRS resource set.

In addition, each PO set can correspond to H MsgA PUSCH resource sets, where a value of His the number of DMRS resources corresponding to each PO in the PO set. The DMRS resource index corresponds to the DMRS resource.

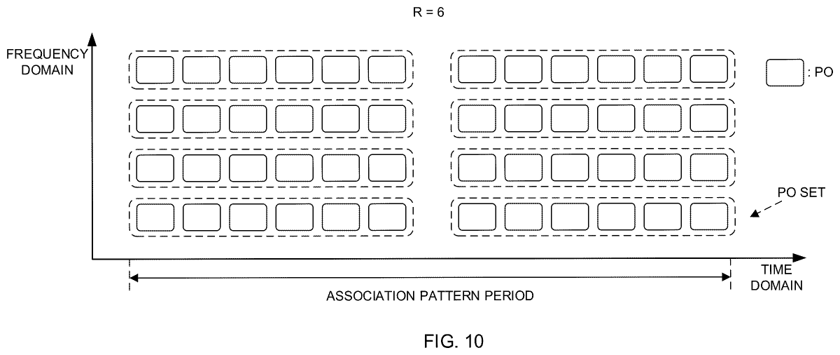

For example, in FIG. 10, there are 48 POs per association pattern period, and each PO corresponds to 4 DMRS resources. Therefore, the total number of MsgA PUSCH resources is 48×4.

The 48 POs are grouped into eight PO sets with R=6, where each PO set can correspond to four MsgA PUSCH resource sets, and each MsgA PUSCH resource set corresponds to six POs that are consecutive in time domain and one DMRS resource, in other words, each MsgA PUSCH resource set corresponds to six POs that are consecutive in time domain and one DMRS resource index.

### 7) MsgA PRACH Resource and MsgA PRACH Resource Set

It should be noted that, the MsgA PRACH resource can be understood as a resource for transmitting (or carrying) a MsgA PRACH.

Each MsgA PRACH resource can correspond to one RO in time domain and one PRACH preamble.

Since the “RO set” is introduced in embodiments of the disclosure, with reference to the concept of “RO set”, the concept of “MsgA PRACH resource set” is also introduced in embodiment of the disclosure. The MsgA PRACH resource set can be understood as a resource for repetitions of MsgA PRACH.

In actual implementation, each MsgA PRACH resource set can correspond to K ROs in time domain and one PRACH preamble.

That is, each MsgA PRACH resource set can correspond to one RO set and one PRACH preamble.

In addition, each RO set can correspond to J MsgA PRACH resource sets, where a value of J is the number of PRACH preambles corresponding to each RO in the RO set.

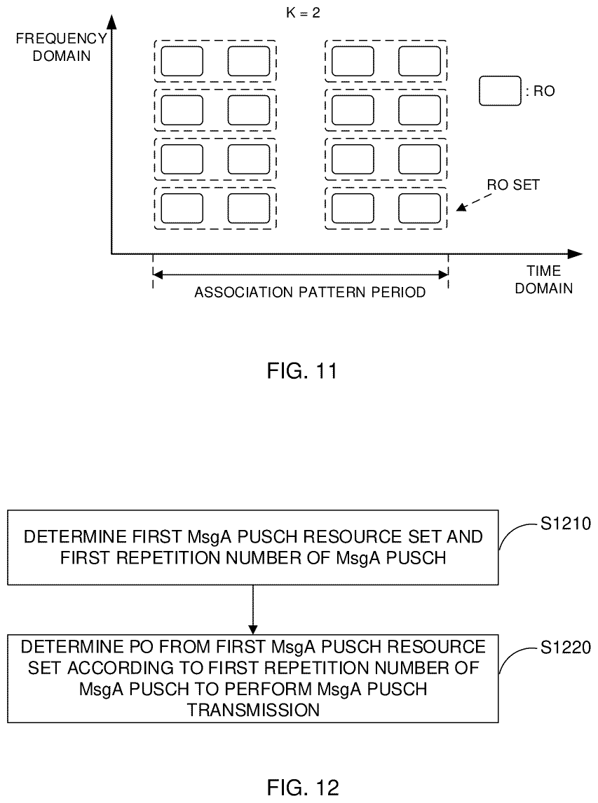

For example, in FIG. 11, there are 16 ROs per association pattern period, where each RO corresponds to 32 PRACH preambles. Therefore, the total number of MsgA PRACH resources is 16×32.

The 16 ROs are grouped into 8 RO sets with K=2, where each RO set can correspond to 32 MsgA PRACH resource sets, and each MsgA PRACH resource set corresponds to two ROs that are consecutive in time domain and one PRACH preamble.

### 8) Mapping Rate Between MsgA PRACH Resource Sets and MsgA PUSCH Resource Sets

It should be noted that, the mapping rate can represent how to perform mapping between MsgA PRACH resource sets and MsgA PUSCH resource sets.

In some possible implementations, if each MsgA PUSCH resource set corresponds to R POs in time domain (for example, R POs that are consecutive in time domain) and one DMRS resource, the mapping rate between MsgA PRACH resource sets and MsgA PUSCH resource sets can be as follows:

$$\begin{matrix}L = ceil ( N / M ) \\ N = {T}_{preamble} / K \\ M = {T}_{PUSCH} / R\end{matrix}$$

L represents the mapping rate. ceil(N/M) represents rounding up N/M, where N represents the total number of MsgA PRACH resource sets per association pattern period, and M represents the total number of the MsgA PUSCH resource sets per association pattern period. T_{preamble} represents the total number of valid ROs per association pattern period multiplied by the number of PRACH preambles per valid RO, that is, the total number of valid MsgA PRACH resources per association pattern period. T_{PUSCH} represents the total number of valid POs per association pattern period multiplied by the number of DMRS resources per valid PO, that is, the total number of valid MsgA PUSCH resources per association pattern period.

It should be noted that, the association pattern period can be determined according to an uplink-downlink resource configuration, an SSB resource location, and a PRACH resource configuration. The location distribution of the MsgA PRACH resource and the SSB resource in different association pattern periods is the same, so as to ensure that a mapping rate between Msg1 resources and POs corresponding to each association pattern period is the same.

In addition, a PO can be valid if the PO does not overlap in time and frequency with an RO associated with a 4-step random access procedure or a 2-step access procedure.

Therefore, it can be understood that, the terminal device can determine the total number T_{preamble} of valid MsgA PRACH resources per association pattern period and the total number T_{PUSCH} of valid MsgA PUSCH resources per association pattern period.

Then, the terminal device can determine the total number N of MsgA PRACH resource sets per association pattern period according to T_{preamble} and the value K of the repetition number of MsgA PRACH, and determine the total number M of MsgA PUSCH resource sets per association pattern period according to T_{PUSCH} and the maximum value R among the candidate value of the repetition number of MsgA PUSCH.

As such, the terminal device can determine the mapping rate L between MsgA PRACH resource sets and MsgA PUSCH resource sets based on N and M.

In some possible implementations, if each MsgA PUSCH resource set corresponds to R POs in time domain and one DMRS resource set, the mapping rate between MsgA PRACH resource sets and MsgA PUSCH resource sets can be as follows:

$$\begin{matrix}L = ceil ( N / M ) \\ N = {T}_{preamble} / K \\ M = {T}_{PUSCH} / ( {R}^{*} Z )\end{matrix}$$

L represents the mapping rate. ceil(N/M) represents rounding up N/M, where N represents the total number of MsgA PRACH resource sets per association pattern period, and M represents the total number of MsgA PUSCH resource sets per association pattern period. T_{preamble} represents the total number of valid ROs per association pattern period multiplied by the number of PRACH preambles per valid RO, that is, the total number of valid MsgA PRACH resources per association pattern period. T_{PUSCH} represents the total number of valid POs per association pattern period multiplied by the number of DMRS resources per valid PO, that is, the total number of valid MsgA PUSCH resources per association pattern period. Z represents the number of DMRS resources per DMRS resource set per association pattern period.

### 9) Mapping (Association/Correspondence, etc.) Between MsgA PRACH Resource Sets and MsgA PUSCH Resource Sets

After the mapping rate L between MsgA PRACH resource sets and MsgA PUSCH resource sets is determined, in embodiments of the disclosure, the mapping between MsgA PRACH transmission resource sets and MsgA PUSCH transmission resource sets can be performed according to the mapping rate L, that is, L MsgA PRACH resource sets are mapped to one MsgA PUSCH resource set.

In some possible implementations, the mapping between MsgA PRACH resource sets and MsgA PUSCH resource sets can be implemented according to the following rules.

Firstly, the MsgA PRACH resource sets are sorted as follows. First, in increasing order of PRACH preamble indexes within a single RO set, that is, MsgA PRACH resource sets in the RO set are sorted in increasing order of PRACH preamble indexes. Second, in frequency domain, frequency multiplexed RO sets are sorted in increasing order of frequency resource indexes. Finally, in time domain, time multiplexed RO sets are sorted in increasing order of time resource indexes.

Then, the MsgA PUSCH resource sets are sorted as follows. First, in frequency domain, frequency multiplexed PO sets are sorted in increasing order of frequency resource indexes. Second, the MsgA PUSCH resource sets are sorted firstly according to DMRS ports and secondly according to DMRS sequences. Finally, in time domain, time multiplexed PO sets are sorted in increasing order of time resource indexes.

After the MsgA PRACH resource sets and the MsgA PUSCH resource sets are sorted, mapping is performed sequentially according to the mapping rate L.

### 10) MsgA Transmission

As can be seen, in embodiments of the disclosure, an RO can be determined from the MsgA PRACH resource set according to the repetition number of MsgA PRACH to perform MsgA PRACH transmission, and a PO can be determined from the MsgA PUSCH resource set according to the repetition number of MsgA PUSCH to perform MsgA PUSCH transmission.

The terminal device is taken as an example for elaboration below.

### 1. Determination of the Repetition Number of MsgA PRACH and at Least One Candidate Value of the Repetition Number of MsgA PUSCH.

According to to the foregoing “1) the repetition number of MsgA PRACH” and “2) the repetition number of MsgA PUSCH”, it can be seen that the terminal device determines the value K of the repetition number of MsgA PRACH and the maximum value R among the at least one candidate value of the repetition number of MsgA PUSCH.

The value of the repetition number of MsgA PRACH can be configured by the network or pre-configured.

The at least one repetition number of MsgA PUSCH can be configured by the network or pre-configured, and can be determined according to the correspondence between the repetition numbers of MsgA PRACH and the repetition numbers of MsgA PUSCH. The correspondence between the repetition numbers of MsgA PRACH and the repetition numbers of MsgA PUSCH can be configured by the network or pre-configured.

For example, the candidate value of the repetition number of MsgA PUSCH determined by the terminal device is {2, 4, 6}, and in this case, R=6.

### 2. Determination of Target SSB

According to to the foregoing “1. selection of SSB”, the terminal device can obtain SS-RSRPs of SSBs through channel estimation, and then compare the SS-RSRPs of the SSBs with the parameter rsrp-ThresholdSSB.

If there is one SSB whose SS-RSRP is greater than the rsrp-ThresholdSSB, the terminal device selects the SSB as the target SSB; otherwise, the terminal device selects randomly one SSB as the target SSB.

If there are multiple SSBs whose the SS-RSRP is greater than the parameter rsrp-ThresholdSSB, the terminal device selects randomly one of the multiple SSBs as the target SSB.

### 3. Determination of Target MsgA PRACH Resource Set

The terminal device can determine the target MsgA PRACH resource set according to the target SSB and the mapping between SSBs and MsgA PRACH resource sets. The target MsgA PRACH resource set corresponds to K ROs in time domain and one PRACH preamble.

### 4. Determination of Target MsgA PUSCH Resource Set

The terminal device can determine the target MsgA PUSCH resource set according to the target MsgA PRACH resource set and the mapping between MsgA PRACH resource sets and MsgA PUSCH resource sets. The target MsgA PUSCH resource set corresponds to R POs in time domain and one DMRS resource or one DMRS resource set.

### 5. Determination of the Actual Repetition Number of MsgA PUSCH

The terminal device can determine the actual repetition number of MsgA PUSCH from the at least one candidate value of the repetition number of MsgA PUSCH according to the RSRP currently measured of the serving cell or according to the satellite ephemeris information and/or the GNSS, so that the terminal device can perform repetitions of a MsgA PUSCH payload according to the actual repetition number of MsgA PUSCH.

That is, the actual repetition number of MsgA PUSCH is one value among the at least one candidate value of the repetition number of MsgA PUSCH, and a value of the actual repetition number of MsgA PUSCH is S, where S≤R.

For example, from the candidate value {2, 4, 6} of the repetition number of MsgA PUSCH, the terminal device determines, according to the RSRP currently measured of the serving cell, that the value of the actual repetition number of MsgA PUSCH is 4, that is, S=4.

### 6. MsgA Transmission

The terminal device can determine an RO from the target MsgA PRACH resource set according to the repetition number of MsgA PRACH to perform MsgA PRACH transmission, and determine a PO from the target MsgA PUSCH resource set according to the actual repetition number of MsgA PUSCH to perform MsgA PUSCH transmission.

In a possible implementation, the RO can be determined from the target MsgA PRACH resource set according to the repetition number of MsgA PRACH to perform MsgA PRACH transmission as follows. K ROs are determined from the target MsgA PRACH resource set according to the repetition number of MsgA PRACH to perform MsgA PRACH transmission.

As can be seen, K repetitions of MsgA PRACH can be realized after determining the K ROs.

In a possible implementation, S POs can be determined from the target MsgA PUSCH resource set according to the actual repetition number of MsgA PUSCH to perform MsgA PUSCH transmission.

As can be seen, S repetitions of MsgA PUSCH can be realized after determining the S POs.

It should be noted that, the target MsgA PUSCH resource set corresponds to R POs, and the S POs can be implemented as follows.

In a possible implementation, the S POs can be the first (foremost/starting, etc.) S POs of the R POs.

It should be noted that, the S POs can be configured by the network, or can be pre-configured, or can be determined autonomously by the terminal.

For example, the network configures the terminal device to use the first S POs in the target MsgA PUSCH resource set to perform MsgA PUSCH transmission.

In a possible implementation, the S POs can be the last (ending, etc.) S POs of the R POs.

It should be noted that, the S POs can be configured by the network, or can be pre-configured, or can be determined autonomously by the terminal.

For example, the terminal autonomously determines the last S POs in the target MsgA PUSCH resource set to perform MsgA PUSCH transmission.

In a possible implementation, the S POs can be any S POs of the R POs.

It should be noted that, the S POs can be configured by the network, or can be pre-configured, or can be determined autonomously by the terminal.

For example, it is pre-configured at the terminal device that the terminal device is to use any S POs in the target MsgA PUSCH resource set to perform MsgA PUSCH transmission.

As can be seen, in embodiments of the disclosure, it is possible to select the S POs flexibly, which is beneficial to improving flexibility and diversity of MsgA PUSCH transmission.

### 11) Indication of the Actual Repetition Number of MsgA PUSCH

It should be noted that, since the actual repetition number of MsgA PUSCH is determined by the terminal device, in order to ensure stability of communication, the terminal device needs to indicate the actual repetition number of MsgA PUSCH to the network device, so that the network device can know the actual repetition number of MsgA PUSCH.

In actual implementation, according to the foregoing “5) DMRS resource and DMRS resource set”, it can be seen that there is a correspondence between DMRS resources and the repetition numbers of MsgA PUSCH, or there is a correspondence (mapping/association, etc.) between DMRS resource sets and the repetition numbers of MsgA PUSCH.

Since the DMRS resource is needed for MsgA PUSCH transmission, in embodiments of the disclosure, the actual repetition number of MsgA PUSCH can be indicated to the network device according to the above correspondence.

For example, with reference to the foregoing Table 3, from the at least one candidate value of the repetition number of MsgA PUSCH, the terminal device determines, according to the satellite ephemeris information and/or the GNSS, that the actual repetition number of MsgA PUSCH is 2.

Then, two POs and one DMRS resource are determined from the target MsgA PUSCH resource set according to the actual repetition number of MsgA PUSCH. It can be seen from the foregoing Table 3 that the repetition number of MsgA PUSCH corresponding to {DMRS 0, DMRS 1} is 2. Therefore, the terminal device can select a DMRS resource randomly from {DMRS 0, DMRS 1} so as to perform MsgA PUSCH transmission. For example, the terminal device can use DMRS 0 to perform MsgA PUSCH transmission.

Finally, the network device determines the repetition number of MsgA PUSCH according to the DMRS resource for the MsgA PUSCH (MsgA PUSCH payload) received. For example, if the terminal device sends a MsgA PUSCH by using DMRS 0, the network device determines, according to the MsgA PUSCH payload received, that the DMRS resource used by the terminal device is DMRS 0, so that the network device can determine, according to DMRS 0 and Table 3, that the actual repetition number of MsgA PUSCH determined by the terminal device is 2.

### (2) The Repetition Number of PUCCH for HARQ-ACK Feedback Information Corresponding to MsgB

### 1) The Repetition Number of PUCCH for HARQ-ACK Feedback Information Corresponding to MsgB

It should be noted that, a PUCCH resource is used for transmitting (or carrying) the HARQ-ACK feedback information corresponding to the MsgB. Therefore, the repetition number of PUCCH for the HARQ-ACK feedback information corresponding to the MsgB can indicate the repetition number of the HARQ-ACK feedback information corresponding to the MsgB.

In some possible implementations, the repetition number of PUCCH for the HARQ-ACK feedback information corresponding to the MsgB can be determined in the following modes.

Mode a: network configuration or pre-configuration.

It should be noted that, the meaning of “network configuration” or “pre-configuration” is similar to that described above.

In actual implementation, the network device can configure for the terminal device one candidate value of the repetition number of PUCCH for the HARQ-ACK feedback information corresponding to the MsgB via higher-layer signaling, so that the terminal device can determine the repetition number of PUCCH for the HARQ-ACK feedback information corresponding to the MsgB according to the higher-layer signaling. Alternatively, the network device can configure for the terminal device at least one candidate value of the repetition number of PUCCH for the HARQ-ACK feedback information corresponding to the MsgB via higher-layer signaling, so that the terminal device can determine the repetition number of PUCCH for the HARQ-ACK feedback information corresponding to the MsgB according to the higher-layer signaling. Alternatively, at least one candidate value of the repetition number of PUCCH for the HARQ-ACK feedback information corresponding to the MsgB is pre-configured at the terminal device, so that the terminal device can determine the repetition number of PUCCH for the HARQ-ACK feedback information corresponding to the MsgB according to the higher-layer signaling.

For example, the network device configures for the terminal device the candidate value of the repetition number of PUCCH as {2, 4, 6} via system information.

In addition, the repetition numbers of PUCCH configured for different terminal devices by the network device can be different.

Mode b: indication by successful random access RAR (successRAR) carried in MsgB

If at least one candidate value of the repetition number of PUCCH is configured by the network or pre-configured, in embodiments of the disclosure, one value can be indicated by the successRAR carried in the MsgB from the at least one candidate value of the repetition number of PUCCH.

In this way, after receiving the MsgB, the terminal device determines the repetition number of PUCCH according to the successRAR carried in the MsgB.

In actual implementation, a bit field is added in the successRAR, where the bit field is used to indicate the repetition number of PUCCH. The bit field indicates one value from the at least one candidate value of the repetition number of PUCCH.

Mode c: determination according to a correspondence between the repetition numbers of MsgA PRACH and the repetition numbers of PUCCH.

It should be noted that, the correspondence between the repetition numbers of MsgA PRACH and the repetition numbers of PUCCH can be configured by the network or pre-configured.

In some possible implementations, in the correspondence, each value of the repetition number of MsgA PRACH can correspond to at least one candidate value of the repetition number of PUCCH.

It should be noted that, if each value of the repetition number of MsgA PRACH corresponds to one value of the repetition number of PUCCH, the terminal device can determine the value of the repetition number of PUCCH directly according to the repetition number of MsgA PRACH.

If each value of the repetition number of MsgA PRACH corresponds to multiple candidate values of the repetition number of PUCCH, the terminal device needs to firstly determine the multiple candidate values of the repetition number of PUCCH according to the value of the repetition number of MsgA PRACH, and then determine one value from the multiple candidate values of the repetition number of PUCCH according to indication of the successRAR carried in the MsgB, that is, after receiving the MsgB, the terminal device determines the repetition number of PUCCH according to the bit field in the successRAR carried in the MsgB.

Exemplarily, the correspondence between the repetition numbers of MsgA PRACH and the repetition numbers of PUCCH is illustrated in Table 4.

TABLE 4

| Repetition number of MsgA PRACH | Repetition number of PUCCH |
|---|---|
| 1 | 2, 4 |
| 2 | 4, 6 |
| 4 | 6, 8 |
| 8 | 12, 16 |

When the value of the repetition number of MsgA PRACH is 1, the candidate value of the repetition number of PUCCH is {2, 4}; when the value of the repetition number of MsgA PRACH is 2, the candidate value of the repetition number of PUCCH is {4, 6}; and so forth.

The “mode c” will be exemplified below with reference to Table 4.

For example, the network device firstly configures for the terminal device the correspondence between the repetition numbers of MsgA PRACH and the repetition numbers of PUCCH illustrated in Table 4 via higher-layer signaling, and then configures for the terminal device the value of the repetition number of MsgA PRACH as 2 via system information.

In this way, the terminal device can determine, according to the value of the repetition number of MsgA PRACH and the correspondence, that the candidate value of the repetition number of PUCCH is {4, 6}.

Finally, the network device indicates the value as 4 from {4, 6} via the successRAR carried in the MsgB. In this way, the terminal device determines that the value of the repetition number of PUCCH is 4.

Mode d: determination according to a correspondence between the repetition numbers of MsgA PUSCH and the repetition numbers of PUCCH.

It should be noted that, the correspondence between the repetition numbers of MsgA PUSCH and the repetition numbers of PUCCH can be configured by the network or pre-configured.

In some possible implementations, in the correspondence, each value of the repetition number of MsgA PUSCH can correspond to at least one candidate value of the repetition number of PUCCH.

It should be noted that, if each value of the repetition number of MsgA PUSCH corresponds to one value of the repetition number of PUCCH, the terminal device can determine the value of the repetition number of PUCCH directly according to the repetition number of MsgA PUSCH.

If each value of the repetition number of MsgA PUSCH corresponds to multiple candidate values of the repetition number of PUCCH, the terminal device needs to firstly determine the multiple candidate values of the repetition number of PUCCH according to the value of the repetition number of MsgA PUSCH, and then determine one value from the multiple candidate values of the repetition number of PUCCH according to indication of the successRAR carried in the MsgB, that is, after receiving the MsgB, the terminal device determines the repetition number of PUCCH according to the bit field in the successRAR carried in the MsgB.

Exemplarily, the correspondence between the repetition numbers of MsgA PUSCH and the repetition numbers of PUCCH is illustrated in Table 5.

When the value of the repetition number of MsgA PUSCH is 2, the candidate value of the repetition number of PUCCH is {2, 4}; when the value of the repetition number of MsgA PUSCH is 4, the candidate value of the repetition number of PUCCH is {4, 6}; and so forth.

The “mode d” will be exemplified below with reference to Table 5.

For example, the network device firstly configures for the terminal device the correspondence between the repetition numbers of MsgA PUSCH and the repetition numbers of PUCCH illustrated in Table 5 via higher-layer signaling, and then configures for the terminal device the value of the repetition number of MsgA PUSCH as 4 via system information.

In this way, the terminal device can determine, according to the value of the repetition number of MsgA PUSCH and the correspondence, that the candidate value of the repetition number of PUCCH is {6, 8}.

Finally, the network device indicates the value as 6 from {6, 8} via the successRAR carried in the MsgB. In this way, the terminal device determines that the value of the repetition number of PUCCH is 6.

TABLE 5

| Repetition number of MsgA PUSCH | Repetition number of PUCCH |
|---|---|
| 2 | 2, 4 |
| 4 | 4, 6 |
| 6 | 6, 8 |
| 8 | 12, 16 |

### V. Exemplary Illustration of a Communication Method

With reference to the above elaboration, a communication method according to embodiments of the disclosure is illustratively introduced, where the method can be applied to a terminal device/chip/chip module/apparatus, and the like, which is not limited herein.

FIG. 12 is a schematic flowchart of a communication method according to embodiments of the disclosure, which specifically includes the following.

S1210, determine a first MsgA PUSCH resource set and a first repetition number of MsgA PUSCH.

The first MsgA PUSCH resource set corresponds to R POs in time domain and one DMRS resource or one DMRS resource set.

S1220, determine a PO from the first MsgA PUSCH resource set according to the first repetition number of MsgA PUSCH to perform MsgA PUSCH transmission.

It should be noted that, according to the foregoing “10) MsgA transmission”, it can be seen that the “first MsgA PUSCH resource set” can be a “target MsgA PUSCH resource set”, and the “first repetition number of MsgA PUSCH” can be the “actual repetition number of MsgA PUSCH”.

As can be seen, in embodiments of the disclosure, the MsgA PUSCH resource set and the repetition number of MsgA PUSCH are introduced, so that the PO can be determined from the MsgA PUSCH resource set according to the repetition number of MsgA PUSCH so as to perform repetitions of MsgA PUSCH, thereby realizing uplink coverage enhancement in a 2-step random access procedure through repetitions of MsgA PUSCH, and thus improving reliability of MsgA transmission.

In some possible implementations, the PO can be determined from the first MsgA PUSCH resource set according to the first repetition number of MsgA PUSCH to perform MsgA PUSCH transmission in S1220 as follows. Determine S POs from the first MsgA PUSCH resource set according to the first repetition number of MsgA PUSCH to perform MsgA PUSCH transmission, where a value of S is the first repetition number of MsgA PUSCH, and S≤R.

As can be seen, S repetitions of MsgA PUSCH can be realized after determining the S POs.

In some possible implementations, the S POs are the first S POs of the R POs. Alternatively, the S POs are the last S POs of the R POs. Alternatively, the S POs are any S POs of the R POs.

As can be seen, in embodiments of the disclosure, it is possible to select the S POs flexibly, which is beneficial to improving flexibility and diversity of MsgA PUSCH transmission.

In some possible implementations, the R POs are consecutive in time domain, and/or each of the R POs corresponds to a same DMRS resource, and/or each of the R POs corresponds to a same number of DMRS resources, and/or the R POs constitute one PO set.

As can be seen, in embodiments of the disclosure, the R POs in time domain corresponding to the MsgA PUSCH resource set can be configured flexibly.

In some possible implementations, a value of R is a second repetition number of MsgA PUSCH.

As can be seen, in embodiments of the disclosure, the number of POs in time domain corresponding to the MsgA PUSCH resource set can be determined according to the value R of the repetition number of MsgA PUSCH.

In some possible implementations, the second repetition number of MsgA PUSCH is a maximum value among at least one candidate value of the repetition number of MsgA PUSCH.

As can be seen, in embodiments of the disclosure, the number of POs in time domain corresponding to the MsgA PUSCH resource set can be determined according to the maximum value R among the at least one candidate value of the repetition number of MsgA PUSCH.

In some possible implementations, at least one candidate value of the repetition number of MsgA PUSCH is configured by a network or pre-configured. Alternatively, at least one candidate value of the repetition number of MsgA PUSCH is determined according to a correspondence between the repetition numbers of MsgA PRACH and the repetition numbers of MsgA PUSCH, where the correspondence between the repetition numbers of MsgA PRACH and the repetition numbers of MsgA PUSCH is configured by the network or pre-configured.

It should be noted that, the repetition number of MsgA PUSCH corresponding to the maximum value among the candidate value of the repetition number of MsgA PUSCH determined in the above “mode I” and “mode II” can be referred to as the “second repetition number of MsgA PUSCH”.

As can be seen, in embodiments of the disclosure, it is possible to configure flexibly at least one candidate value of the repetition number of MsgA PUSCH, which is beneficial to improving flexibility and diversity in determination of the repetition number of MsgA PUSCH.

In some possible implementations, the first repetition number of MsgA PUSCH is determined according to a signal measurement result of a serving cell, or the first repetition number of MsgA PUSCH is determined according to satellite ephemeris information and/or satellite navigation information.

It should be noted that, the repetition number of MsgA PUSCH determined in “mode 1” or “mode 2” in the above “mode I” can be referred to as the “first repetition number of MsgA PUSCH”.

As can be seen, in embodiments of the disclosure, it is possible to determine flexibly the repetition number of MsgA PUSCH through different communication scenarios.

Further, the first repetition number of MsgA PUSCH is determined from the at least one candidate value of the repetition number of MsgA PUSCH according to the signal measurement result of the serving cell. The at least one candidate value of the repetition number of MsgA PUSCH is configured by the network or pre-configured; or the at least one candidate value of the repetition number of MsgA PUSCH is determined according to a correspondence between the repetition numbers of MsgA PRACH and the repetition numbers of MsgA PUSCH, where the correspondence between the repetition numbers of MsgA PRACH and the repetition numbers of MsgA PUSCH is configured by the network or pre-configured.

In some possible implementations, the first MsgA PUSCH resource set is determined according to a mapping between a first MsgA PRACH resource set and the first MsgA PUSCH resource set, where the first MsgA PRACH resource set corresponds to K ROs in time domain and one random access preamble.

It should be noted that, according to the foregoing “10) MsgA transmission”, the “first MsgA PRACH resource set” can be a “target MsgA PRACH resource set”.

As can be seen, in embodiments of the disclosure, it is possible to determine the first MsgA PUSCH resource set according to the mapping between the first MsgA PRACH resource set and the first MsgA PUSCH resource set.

In some possible implementations, the K ROs are consecutive in time domain, and/or each of the K ROs corresponds to a same random access preamble, and/or each of the K ROs corresponds to a same number of random access preambles; and/or the K ROs constitute one RO set.

As can be seen, in embodiments of the disclosure, the K ROs in time domain corresponding to the MsgA PRACH resource set can be configured flexibly.

In some possible implementations, a value of K is a first repetition number of MsgA PRACH, where the first repetition number of MsgA PRACH is configured by the network or pre-configured.

As can be seen, in embodiments of the disclosure, it is possible to determine the number of ROs in time domain corresponding to the MsgA PRACH resource set according to the value K of the repetition number of MsgA PRACH.

In some possible implementations, the first MsgA PRACH resource set is determined according to a mapping between SSBs and ROs.

As can be seen, in embodiment of the disclosure, it is possible to determine the first MsgA PRACH resource set according to the mapping between SSBs and ROs.

In some possible implementations, if the first MsgA PUSCH resource set corresponds to R POs in time domain and one DMRS resource, a mapping rate between the first MsgA PRACH resource set and the first MsgA PUSCH resource set is:

$$\begin{matrix}L = ceil ( N / M ) \\ N = {T}_{preamble} / K \\ M = {T}_{PUSCH} / R\end{matrix}$$

L represents the mapping rate, ceil(N/M) represents rounding up N/M, N represents the total number of MsgA PRACH resource sets per association pattern period, M represents the total number of MsgA PUSCH resource sets per association pattern period, T_{preamble} represents the total number of valid ROs per association pattern period multiplied by the number of random access preambles per valid RO, and T_{PUSCH} represents the total number of valid POs per association pattern period multiplied by the number of DMRS resources per valid PO.

As can be seen, in embodiments of the disclosure, it is possible to perform mapping between the first MsgA PRACH transmission resource set and the first MsgA PUSCH transmission resource set according to the mapping rate L, i. e. L first MsgA PRACH resource sets are mapped to one first MsgA PUSCH resource set.

In some possible implementations, if the first MsgA PUSCH resource set corresponds to R POs in time domain and one DMRS resource set, a mapping rate between the first MsgA PRACH resource set and the first MsgA PUSCH resource set is:

$$\begin{matrix}L = ceil ( N / M ) \\ N = {T}_{preamble} / K \\ M = {T}_{PUSCH} / ( {R}^{*} Z )\end{matrix}$$

L represents the mapping rate, ceil(N/M) represents rounding up N/M, N represents the total number of MsgA PRACH resource sets per association pattern period, M represents the total number of MsgA PUSCH resource sets per association pattern period, T_{preamble} represents the total number of valid ROs per association pattern period multiplied by the number of random access preambles per valid RO, T_{PUSCH} represents the total number of valid POs per association pattern period multiplied by the number of DMRS resources per valid PO, and Z represents the number of DMRS resources per DMRS resource set per association pattern period.

As can be seen, in embodiments of the disclosures, it is possible to perform mapping between the first MsgA PRACH transmission resource set and the first MsgA PUSCH transmission resource set according to the mapping rate L, i. e. L first MsgA PRACH resource sets are mapped to one first MsgA PUSCH resource set.

In some possible implementations, different DMRS resources in the DMRS resource set correspond to different repetition numbers of MsgA PUSCH.

In some possible implementations, the method can further include the following: indicate the first repetition number of MsgA PUSCH to a network device.

It should be noted that, according to the foregoing “11) indication of the actual repetition number of MsgA PUSCH”, it can be seen that since the first repetition number of MsgA PUSCH is determined by the terminal device, in order to ensure stability of communication, the terminal device needs to indicate the first repetition number of MsgA PUSCH to the network device so that the network device can know the first repetition number of MsgA PUSCH.

In some possible implementations, the first repetition number of MsgA PUSCH is indicated by a correspondence between DMRS resources or DMRS resource sets and the repetition number of MsgA PUSCH, where the correspondence between DMRS resources or DMRS resource sets and the repetition numbers of MsgA PUSCH is configured by the network or pre-configured.

It should be noted that, since the DMRS resource is needed for first MsgA PUSCH transmission, in embodiments of the disclosure, the first repetition number of MsgA PUSCH is indicated to the network device according to the correspondence between DMRS resources or DMRS resource sets and the repetition numbers of MsgA PUSCH.

### VI. Exemplary Illustration of Another Communication Method

With reference to the above elaboration, a communication method according to embodiments of the disclosure is illustratively introduced, where the method can be applied to a terminal device/chip/chip module/apparatus, and the like, which is not limited herein.

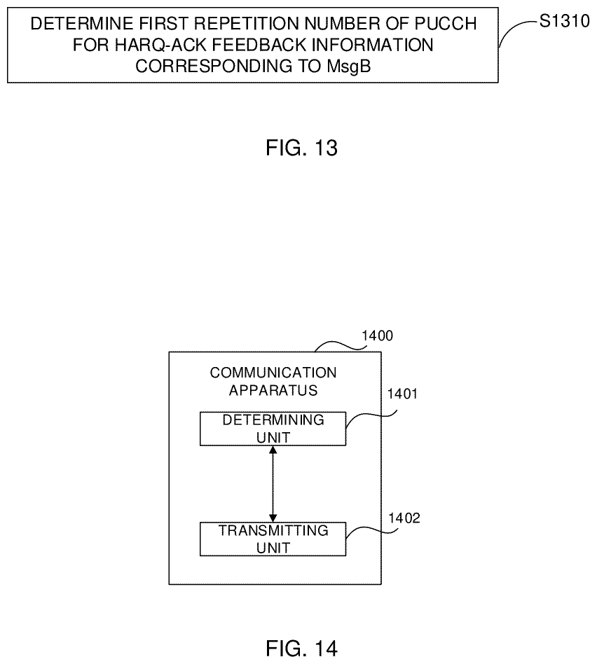

FIG. 13 is a schematic flowchart of a communication method according to embodiments of the disclosure. The method includes the following.

S1310, determine a first repetition number of PUCCH for HARQ-ACK feedback information corresponding to MsgB.

It should be noted that, according to the foregoing “(2) the repetition number of PUCCH for HARQ-ACK feedback information corresponding to MsgB”, it can be seen that a PUCCH resource is used for transmitting (or carrying) the HARQ-ACK feedback information corresponding to the MsgB, and therefore, the first repetition number of PUCCH can indicate the repetition number of HARQ-ACK corresponding to the MsgB.

In addition, the first repetition number of PUCCH is the repetition number of PUCCH, and can be described by other terms such as a target repetition number of PUCCH, which shall all belong to the protection scope of the disclosure as long as they have the same meaning/explanation/illustration.

As can be seen, in embodiments of the disclosure, the repetition number of PUCCH for the HARQ-ACK feedback information corresponding to the MsgB is introduced, so that the HARQ-ACK feedback information corresponding to the MsgB can be transmitted by means of repetitions according to the repetition number of MsgA PUSCH, thereby realizing uplink coverage enhancement in a two-step random access procedure through repetitions of the HARQ-ACK feedback information corresponding to the MsgB, and thus improving transmission reliability of the HARQ-ACK feedback information corresponding to the MsgB.

In some possible implementations, the first repetition number of PUCCH is configured by a network or pre-configured. Alternatively, the first repetition number of PUCCH is determined according to a correspondence between the repetition numbers of MsgA PRACH and the repetition numbers of PUCCH, where the correspondence between the repetition numbers of MsgA PRACH and the repetition numbers of PUCCH is configured by the network or pre-configured. Alternatively, the first repetition number of PUCCH is determined according to a correspondence between the repetition numbers of MsgA PUSCH and the repetition numbers of PUCCH, where the correspondence between the repetition numbers of MsgA PUSCH and the repetition numbers of PUCCH is configured by the network or pre-configured.

As can be seen, in embodiment of the disclosure, the first repetition number of PUCCH can be configured flexibly.

In some possible implementations, the first repetition number of PUCCH is one indicated by successRAR carried in the MsgB from at least one candidate value of the repetition number of PUCCH.

As can be seen, in embodiment of the disclosure, the first repetition number of PUCCH can be indicated by the successRAR carried in the MsgB.

In some possible implementations, the at least one candidate value of the repetition number of PUCCH is configured by the network or pre-configured. Alternatively, the at least one candidate value of the repetition number of PUCCH is determined according to a correspondence between the repetition numbers of MsgA PRACH and the repetition numbers of PUCCH, and the correspondence between the repetition numbers of MsgA PRACH and the repetition numbers of PUCCH is configured by the network or pre-configured. Alternatively, the at least one candidate value of the repetition number of PUCCH is determined according to a correspondence between the repetition numbers of MsgA PUSCH and the repetition numbers of PUCCH, and the correspondence between the repetition numbers of MsgA PUSCH and the repetition numbers of PUCCH is configured by the network or pre-configured.

As can be seen, in embodiments of the disclosure, the at least one candidate value of the repetition number of PUCCH can be configured flexibly.

### VII. Exemplary Illustration of Communication Apparatus

The solutions of the embodiments of the disclosure are described mainly from the perspective of the method side. It can be understood that, in order to implement the foregoing functions, the terminal device or the network device includes hardware structures and/or software modules for performing respective functions. Those of ordinary skill in the art will appreciate that units and algorithmic operations of various examples described in connection with embodiments of the disclosure can be implemented by hardware or by a combination of hardware and computer software in the disclosure. Whether these functions are performed by means of hardware or hardware driven by computer software depends on the particular application and the design constraints of the associated technical solution. Those skilled in the art can use different methods with regard to each particular application to implement the described functionality, but such methods should not be regarded as lying beyond the scope of the disclosure.

In embodiments of the disclosure, division of functional units of the terminal device or the network device can be implemented according to the above method embodiments in embodiments of the disclosure. For example, various functional units can be divided to be in one-to-one correspondence with each function, or two or more functions can be integrated into one processing unit. The integrated unit can be implemented in the form of hardware, or can be implemented in the form of software program module. It is to be noted that, division of units in embodiments of the disclosure is illustrative and is only a division of logical functions, and there can be other manners of division in practice.

When an integrated unit is used, FIG. 14 is a block diagram illustrating functional units of a communication apparatus according to embodiments of the disclosure. The communication apparatus 1400 includes a determining unit 1401 and a transmitting unit 1402.

It should be noted that, the determining unit 1401 can be a module unit configured to transmit and receive signals, data, information, and the like.

The transmitting unit 1402 can be a module unit configured to process a signal, data, information, and the like, which is not specifically limited herein.

The communication apparatus 1400 can further include a storage unit. The storage unit is configured to store computer program codes or instructions executable by the communication apparatus 1400. The storage unit can be a memory.

In addition, it should be noted that, the communication apparatus 1400 can be a chip or a chip module.

In some possible implementations, the determining unit 1401 and the transmitting unit 1402 can be integrated into one unit or can be separate units.

For example, the determining unit 1401 and the transmitting unit 1402 can be integrated into a communication unit, where the communication unit can be a communication interface, a transceiver, a transceiver circuit, or the like.

For another example, the determining unit 1401 and the transmitting unit 1402 can be integrated into a processing unit, where the processing unit can be a processor or a controller, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof, which can implement or perform the various illustrative logical blocks, modules, and circuits described in connection with the disclosure. The processing unit can also be a combination for implementing computing functions, for example, a combination including one or more microprocessors, a combination of a DSP and a microprocessor, and the like.

For another example, the determining unit 1401 can be integrated into a processing unit, and the transmitting unit 1402 can be integrated into a communication unit.

In actual implementation, the determining unit 1401 and the transmitting unit 1402 are configured to perform any one of the steps performed by the terminal device, the chip, the chip module, and the like in the foregoing method embodiments. Detailed elaboration will be given below.

The determining unit 1401 is configured to determine a first MsgA PUSCH resource set and a first repetition number of MsgA PUSCH, where the first MsgA PUSCH resource set corresponds to R POs in time domain and one DMRS resource or one DMRS resource set. The transmitting unit 1402 is configured to determine a PO from the first MsgA PUSCH resource set according to the first repetition number of MsgA PUSCH to perform MsgA PUSCH transmission.

As can be seen, in embodiments of the disclosure, a MsgA PUSCH resource set and the repetition number of MsgA PUSCH are introduced, so that a PO can be determined from the MsgA PUSCH resource set according to the repetition number of MsgA PUSCH so as to perform repetitions of MsgA PUSCH, which can realize uplink coverage enhancement in a 2-step random access procedure through repetitions of MsgA PUSCH, thereby improving reliability of MsgA transmission.

It should be noted that, for the implementation of each operation in the embodiment illustrated in FIG. 14, reference can be made to the elaboration in the foregoing method embodiments, which is not described again herein.

In some possible implementations, in terms of determining the PO from the first MsgA PUSCH resource set according to the first repetition number of MsgA PUSCH to perform MsgA PUSCH transmission, the transmitting unit 1402 is configured to determine S POs from the first MsgA PUSCH resource set according to the first repetition number of MsgA PUSCH to perform MsgA PUSCH transmission, where a value of S is the first repetition number of MsgA PUSCH, S≤R.

In some possible implementations, the S POs are the first S POs of the R POs; or the S POs are the last S POs of the R POs; or the S POs are any S POs of the R POs.

In some possible implementations, the R POs are consecutive in time domain; and/or each of the R POs corresponds to a same DMRS resource; and/or each of the R POs corresponds to a same number of DMRS resources; and/or the R POs constitute one PO set.

In some possible implementations, a value of R is a second repetition number of MsgA PUSCH.

In some possible implementations, the second repetition number of MsgA PUSCH is a maximum value among at least one candidate value of the repetition number of MsgA PUSCH.

In some possible implementations, the at least one candidate value of the repetition number of MsgA PUSCH is configured by a network or pre-configured. Alternatively, the at least one candidate value of the repetition number of MsgA PUSCH is determined according to a correspondence between the repetition numbers of MsgA PRACH and the repetition numbers of MsgA PUSCH, where the correspondence between the repetition numbers of MsgA PRACH and the repetition numbers of MsgA PUSCH is configured by the network or pre-configured.

In some possible implementations, the first repetition number of MsgA PUSCH is determined according to a signal measurement result of a serving cell; or the first repetition number of MsgA PUSCH is determined according to satellite ephemeris information and/or satellite navigation information.

In some possible implementations, the first MsgA PUSCH resource set is determined according to a mapping between a first MsgA PRACH resource set and the first MsgA PUSCH resource set, and the first MsgA PRACH resource set corresponds to K ROs in time domain and one random access preamble.

In some possible implementations, the K ROs are consecutive in time domain; and/or each of the K ROs corresponds to a same random access preamble; and/or each of the K ROs corresponds to a same number of random access preambles; and/or the K ROs constitute one RO set.

In some possible implementations, a value of K is a first repetition number of MsgA PRACH, and the first repetition number of MsgA PRACH is configured by a network or pre-configured.

In some possible implementations, the first MsgA PRACH resource set is determined according to a mapping between SSBs and ROs.

In some possible implementations, if the first MsgA PUSCH resource set corresponds to R POs in time domain and one DMRS resource, a mapping rate between the first MsgA PRACH resource set and the first MsgA PUSCH resource set is as follows:

$$\begin{matrix}L = ceil ( N / M ) \\ N = {T}_{preamble} / K \\ M = {T}_{PUSCH} / R\end{matrix}$$

L represents the mapping rate, ceil(N/M) represents rounding up N/M, N represents the total number of MsgA PRACH resource sets per association pattern period, M represents the total number of MsgA PUSCH resource sets per association pattern period, T_{preamble} represents the total number of valid ROs per association pattern period multiplied by the number of random access preambles per valid RO, and T_{PUSCH} represents the total number of valid POs per association pattern period multiplied by the number of DMRS resources per valid PO.

In some possible implementations, if the first MsgA PUSCH resource set corresponds to R POs in time domain and one DMRS resource set, a mapping rate between the first MsgA PRACH resource set and the first MsgA PUSCH resource set is as follows:

$$\begin{matrix}L = ceil ( N / M ) \\ N = {T}_{preamble} / K \\ M = {T}_{PUSCH} / ( {R}^{*} Z )\end{matrix}$$

L represents the mapping rate, ceil(N/M) represents rounding up N/M, N represents the total number of MsgA PRACH resource sets per pattern period, M represents the total number of MsgA PUSCH resource sets per association pattern period, T_{preamble} represents the total number of valid ROs per association pattern period multiplied by the number of random access preambles per valid RO, T_{PUSCH} represents the total number of valid POs per association pattern period multiplied by the number of DMRS resources per valid PO, and Z represents the number of DMRS resources per DMRS resource set per association pattern period.

In some possible implementations, different DMRS resources in the DMRS resource set correspond to different repetition numbers of MsgA PUSCH.

In some possible implementations, the communication apparatus 1400 further includes an indication unit. The indication unit is configured to indicate the first repetition number of MsgA PUSCH to a network device.

In some possible implementations, the first repetition number of MsgA PUSCH is indicated by a correspondence between DMRS resources or DMRS resource sets and the repetition numbers of MsgA PUSCH, and the correspondence between DMRS resources or DMRS resource sets and the repetition numbers of MsgA PUSCH is configured by a network or pre-configured.

### VIII. Exemplary Illustration of Another Communication Apparatus

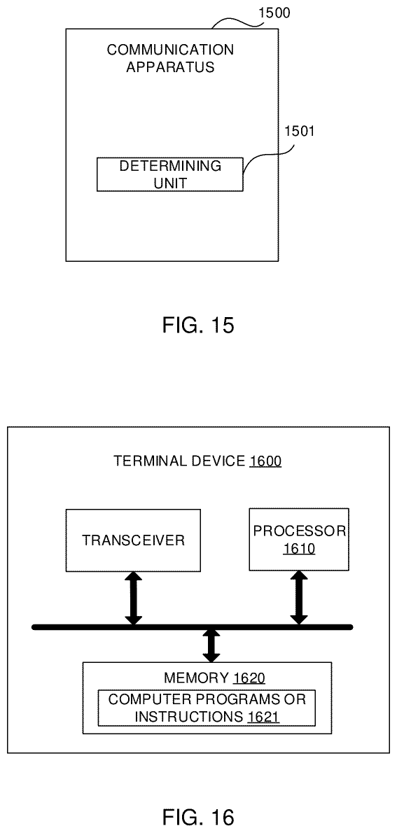

When an integrated unit is used, FIG. 15 is a block diagram illustrating functional units of another communication apparatus according to embodiments of the disclosure. The communication apparatus 1500 includes a determining unit 1501.

It should be noted that, the determining unit 1501 can be a module unit configured to transmit and receive signals, data, information, and the like, which is not specifically limited herein.

The communication apparatus 1500 can further include a storage unit. The storage unit is configured to computer program codes or instructions executable by the communication apparatus 1500. The storage unit can be a memory.

In addition, it should be noted that, the communication apparatus 1500 can be a chip or a chip module.

In some possible implementations, the determining unit 1501 can be integrated into a communication unit, where the communication unit can be a communication interface, a transceiver, a transceiver circuit, etc.

In some possible implementations, the determining unit 1501 is integrated into a processing unit, where the processing unit can be a processor or a controller, for example, a CPU, a general-purpose processor, a DSP, an ASIC, an FPGA, or other programmable logic devices, transistor logic devices, hardware components, or any combination thereof, which can implement or perform the various illustrative logical blocks, modules, and circuits described in connection with the disclosure. The processing unit can also be a combination for implementing computing functions, for example, a combination including one or more microprocessors, a combination of a DSP and a microprocessor, and the like.

In actual implementation, the determining unit 1501 is configured to perform any step perform by a terminal device, a chip, a chip module, or the like in the foregoing method embodiments. Detailed elaborations will be given below.

The determining unit 1501 is configured to determine a first repetition number of PUCCH for HARQ-ACK feedback information corresponding to MsgB.

As can be seen, in embodiments of the disclosure, the repetition number of PUCCH for the HARQ-ACK feedback information corresponding to the MsgB is introduced, so that repetitions of the HARQ-ACK feedback information corresponding to the MsgB can be implemented according to the repetition number of MsgA PUCCH, which is possible to realize uplink coverage enhancement in a 2-step random access procedure through repetitions of the HARQ-ACK feedback information corresponding to the MsgB, thereby improving reliability of transmission of the HARQ-ACK feedback information corresponding to the MsgB.

It should be noted that, for the implementation of each operation in the embodiment illustrated in FIG. 15, reference can be made to the elaboration in the foregoing method embodiments, which is not described again herein.

In some possible implementations, the first repetition number of PUCCH is configured by a network or pre-configured. Alternatively, the first repetition number of PUCCH is determined according to a correspondence between the repetition numbers of MsgA PRACH and the repetition numbers of PUCCH, where the correspondence between the repetition numbers of MsgA PRACH and the repetition numbers of PUCCH is configured by the network or pre-configured. Alternatively, the first repetition number of PUCCH is determined according to a correspondence between the repetition numbers of MsgA PUSCH and the repetition numbers of PUCCH, where the correspondence between the repetition numbers of MsgA PUSCH and the repetition numbers of PUCCH is configured by the network or pre-configured.

In some possible implementations, the first repetition number of PUCCH is one indicated by successRAR carried in the MsgB from at least one candidate value of the repetition number of PUCCH.

In some possible implementations, the at least one candidate value of the repetition number of PUCCH is configured by a network or pre-configured. Alternatively, the at least one candidate value of the repetition number of PUCCH is determined according to a correspondence between the repetition numbers of MsgA PRACH and the repetition numbers of PUCCH, where the correspondence between the repetition numbers of MsgA PRACH and the repetition numbers of PUCCH is configured by the network or pre-configured. Alternatively, the at least one candidate value of the repetition number of PUCCH is determined according to a correspondence between the repetition numbers of MsgA PUSCH and the repetition numbers of PUCCH, where the correspondence between the repetition numbers of MsgA PUSCH and the repetition numbers of PUCCH is configured by the network or pre-configured.

### IX. Exemplary Illustration of Terminal Device

Referring to FIG. 16, FIG. 16 is a schematic structural diagram of a terminal device according to embodiments of the disclosure. The terminal device 1600 includes a processor 1610, a memory 1620, and a communication bus that is configured to connect the processor 1610 and the memory 1620.

The memory 1620 includes, but is not limited to, a random access memory (RAM), a read-only memory (ROM), an erasable programmable ROM (EPROM), or a compact disk ROM (CD-ROM). The memory 1620 is configured to store program codes executable by the terminal device 1600 and data to-be-transmitted.

The terminal device 1600 further includes a communication interface for data transmission and reception.

The processor 1610 can be one or more CPUs. When the processor 1610 is one CPU, the CPU can be a single-core CPU or a multi-core CPU.

The processor 1610 in the terminal device 1600 is configured to execute computer programs or instructions 1621 stored in the memory 1620, to perform the following operations: determine a first MsgA PUSCH resource set and a first repetition number of MsgA PUSCH, where the first MsgA PUSCH resource set corresponds to R POs in a time domain and one DMRS resource or one DMRS resource set; and determine a PO from the first MsgA PUSCH resource set according to the first repetition number of MsgA PUSCH to perform MsgA PUSCH transmission.

As can be seen, in embodiments of the disclosure, a MsgA PUSCH resource set and the repetition number of MsgA PUSCH are introduced, so that a PO can be determined from the MsgA PUSCH resource set according to the repetition number of MsgA PUSCH so as to perform repetitions of MsgA PUSCH, which can realize uplink coverage enhancement in a 2-step random access procedure through repetitions of MsgA PUSCH, thereby improving reliability of MsgA transmission.

It should be noted that, for the implementation of each operation, reference can be made to the corresponding elaboration in the foregoing method embodiments. The terminal device 1600 can be configured to perform the method at a terminal-device side in the foregoing method embodiments of the disclosure, which is not described again herein.

### X. Exemplary Illustration of Terminal Device

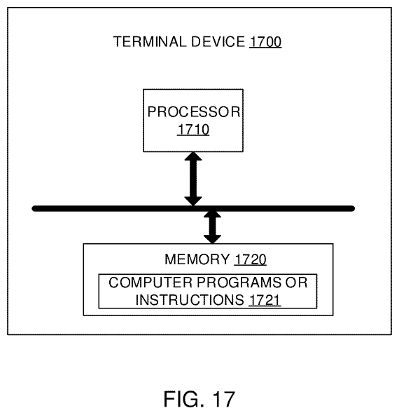

Referring to FIG. 17, FIG. 17 is a schematic structural diagram of another terminal device according to embodiments of the disclosure. The terminal device 1700 includes a processor 1710, a memory 1720, and a communication bus configured to connect the processor 1710 and the memory 1720.

The memory 1720 includes, but is not limited to, a RAM, a ROM, an EPROM, or a CD-ROM. The memory 1720 is configured to store related instructions and data.

The terminal device 1700 further includes a communication interface for data transmission and reception.

The processor 1710 can be one or more CPUs. When the processor 1710 is one CPU, the CPU can be a single-core CPU or a multi-core CPU.

The processor 1710 in the terminal device 1700 is configured to execute computer programs or instructions 1721 stored in the memory 1720 to perform the following operations: determine a first repetition number of PUCCH for HARQ-ACK feedback information corresponding to MsgB.

As can be seen, in embodiments of the disclosure, the repetition number of PUCCH for the HARQ-ACK feedback information corresponding to the MsgB is introduced, so that repetitions of the HARQ-ACK feedback information corresponding to the MsgB can be implemented according to the repetition number of MsgA PUCCH, which is possible to realize uplink coverage enhancement in a 2-step random access procedure through repetitions of the HARQ-ACK feedback information corresponding to the MsgB, thereby improving reliability of transmission of the HARQ-ACK feedback information corresponding to the MsgB.

It should be noted that, for the implementation of each operation, reference can be made to the corresponding elaboration in the foregoing method embodiments. The terminal device 1700 can be configured to perform the method at a terminal-device side in the foregoing method embodiments of the disclosure, which is not described again herein.

### XI. Other Exemplary Illustration

Embodiments of the disclosure further provide a chip. The chip includes a processor, a memory, and computer program or instructions stored in the memory. The processor is configured to execute the computer program or instructions to implement steps described in the foregoing method embodiments.

Embodiments of the disclosure further provide a chip module. The chip module includes a transceiver component and a chip. The chip comprises a processor, a memory, and computer program or instructions stored in the memory. The processor is configured to execute the computer program or instructions to implement steps described in the foregoing method embodiments.

Embodiments of the disclosure further provides a computer-readable storage medium. The computer-readable storage medium stores computer programs or instructions which, when executed, are operable to perform the steps described in the foregoing method embodiments.

Embodiments of the disclosure further provide a computer program product. The computer program product includes computer programs or instructions, which when executed, are operable to perform the steps described in the foregoing method embodiments.

In the above embodiments, the illustration of each embodiment in the embodiments of the disclosure has its own emphasis. For part not described in detail in an embodiment, reference can be made to to the related elaborations in other embodiments.

The steps of the method or algorithm described in the embodiments of the disclosure can be implemented by means of hardware, or can be implemented by means of software instructions executed by a processor. The software instruction can consist of corresponding software modules, which can be stored in a RAM, a flash memory, a ROM, an EPROM, an electrically EPROM (EEPROM), a register, a hard disk, a removable disk, a CD-ROM, or any other form of storage medium known in the art. An exemplary storage medium is coupled to the processor such that the processor can read information from the storage medium and write information to the storage medium. The storage medium can also be a part of the processor, and the processor and the storage medium can be located in an ASIC. In addition, the ASIC can be located in a terminal device or a management device. The processor and the storage medium can also be located in the terminal device or the management device as discrete components.

Those skilled in the art will appreciate that, all or part of functions described in embodiments of the disclosure can be implemented through software, hardware, firmware, or any other combination thereof. When implemented by software, all or part of the functions can be implemented in the form of a computer program product. The computer program product includes one or more computer instructions. When the computer instructions are applied and executed on a computer, all or part of the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disk (DVD)), or a semiconductor medium (such as a solid state disk (SSD)), etc.

Various modules/units in various devices and products described in the foregoing embodiments can be software module/units, or can be hardware module/units, or some are software module/units and the rest are hardware module/units. For example, with regard to various devices or products applied to or integrated into a chip, various modules/units included therein can all be implemented by means of hardware such as a circuit; or at least some of the modules/units can be implemented by means of a software program run on a processor integrated in the chip, and the rest (if any) modules/units can be implemented by means of hardware such as a circuit. With regard to various devices and products applied to or integrated into a chip module, various modules/units included therein can all be implemented by means of hardware such as circuit, and different modules/units can be located in the same component (e. g. chip, circuit module, etc.) or different components of the chip module. Alternatively, at least some of the modules/units can be implemented by means of a software program run on a processor integrated into the chip module, and the rest (if any) of the modules/units can be implemented by means of hardware such as circuit. With regard to various devices and products applied to or integrated into a terminal device, various modules/units included therein can all be implemented by means of hardware such as circuit, and different modules/units can be located in the same component (e. g. chip, circuit module, etc.) or different components of the terminal device. Alternatively, at least some of the modules/units can be implemented by means of a software program run on a processor integrated into the terminal device, and the rest (if any) of the modules/units can be implemented by means of hardware such as circuit. The objectives, technical solutions, and advantages of the embodiments of the disclosure are described in detail in the foregoing implementations, It should be understood that, the foregoing elaborations are merely implementations of the embodiments of the disclosure, but are not intended to limit the protection scope of the embodiments of the disclosure. Any modifications, equivalent replacements, improvements, and the like made on the basis of the technical solutions of the embodiments of the disclosure shall all belong to the protection scope of the embodiments of the disclosure.

I/We claim:

1. A communication method, applied to a terminal device and comprising:
determining a first random access request message (message A, MsgA) physical uplink shared channel (PUSCH) resource set and a first repetition number of MsgA PUSCH, wherein the first MsgA PUSCH resource set corresponds to R PUSCH occasions (PO) in time domain and one demodulation reference signal (DMRS) resource or one DMRS resource set; and
determining a PO from the first MsgA PUSCH resource set according to the first repetition number of MsgA PUSCH to perform MsgA PUSCH transmission.

2. The method of claim 1, wherein determining the PO from the first MsgA PUSCH resource set according to the first repetition number of MsgA PUSCH to perform MsgA PUSCH transmission comprises:
determining S POs from the first MsgA PUSCH resource set according to the first repetition number of MsgA PUSCH to perform MsgA PUSCH transmission, wherein a value of S is the first repetition number of MsgA PUSCH, S≤R.

3. The method of claim 1, wherein the first MsgA PUSCH resource set is determined according to a mapping between a first MsgA PRACH resource set and the first MsgA PUSCH resource set, and the first MsgA PRACH resource set corresponds to K PRACH occasions (RO) in time domain and one random access preamble.

4. The method of claim 3, wherein
the K ROs are consecutive in time domain; and/or
each of the K ROs corresponds to a same random access preamble; and/or
each of the K ROs corresponds to a same number of random access preambles; and/or
the K ROs constitute one RO set.

5. The method of claim 3, wherein a value of K is a first repetition number of MsgA PRACH, and the first repetition number of MsgA PRACH is configured by a network or pre-configured.

6. The method of claim 3, wherein the first MsgA PRACH resource set is determined according to a mapping between synchronization signal and physical broadcast channel (PBCH) blocks (SSB) and ROs.

7. The method of claim 3, wherein in response to the first MsgA PUSCH resource set corresponding to R POs in time domain and one DMRS resource, a mapping rate between the first MsgA PRACH resource set and the first MsgA PUSCH resource set is:
$$\begin{matrix}L = ceil ( N / M ) \\ N = {T}_{preamble} / K \\ M = {T}_{PUSCH} / R\end{matrix}$$
wherein L represents the mapping rate, ceil (N/M) represents rounding up N/M, N represents the total number of MsgA PRACH resource sets per association pattern period, M represents the total number of MsgA PUSCH resource sets per association pattern period, T_{preamble} represents the total number of valid ROs per association pattern period multiplied by the number of random access preambles per valid RO, and T_{PUSCH} represents the total number of valid POs per association pattern period multiplied by the number of DMRS resources per valid PO.

8. The method of claim 3, wherein in response to the first MsgA PUSCH resource set corresponding to R POs in time domain and one DMRS resource set, a mapping rate between the first MsgA PRACH resource set and the first MsgA PUSCH resource set is:
$$\begin{matrix}L = ceil ( N / M ) \\ N = {T}_{preamble} / K \\ M = {T}_{PUSCH} / ( {R}^{*} Z )\end{matrix}$$
wherein L represents the mapping rate, ceil(N/M) represents rounding up N/M, N represents the total number of MsgA PRACH resource sets per pattern period, M represents the total number of MsgA PUSCH resource sets per association pattern period, T_{preamble} represents the total number of valid ROs per association pattern period multiplied by the number of random access preambles per valid RO, T_{PUSCH} represents the total number of valid POs per association pattern period multiplied by the number of DMRS resources per valid PO, and Z represents the number of DMRS resources per DMRS resource set per association pattern period.

9. The method of claim 1, further comprising:
indicating the first repetition number of MsgA PUSCH to a network device.

10. A communication method, applied to a terminal device and comprising:
determining a first repetition number of physical uplink control channel (PUCCH) for hybrid automatic repeat request-acknowledgement (HARQ-ACK) feedback information corresponding to a random access response (RAR) message (message B, MsgB).

11. The method of claim 10, wherein the first repetition number of PUCCH is one indicated by a success RAR (successRAR) carried in MsgB from at least one candidate value of the repetition number of PUCCH.

12. A terminal device, comprising;
a transceiver;
a processor; and
a memory storing computer programs which, when executed by the processor, are operable with the processor to:
determine a first random access request message (message A, MsgA) physical uplink shared channel (PUSCH) resource set and a first repetition number of MsgA PUSCH, wherein the first MsgA PUSCH resource set corresponds to R PUSCH occasions (PO) in time domain and one demodulation reference signal (DMRS) resource or one DMRS resource set; and
determine a PO from the first MsgA PUSCH resource set according to the first repetition number of MsgA PUSCH for the transceiver to perform MsgA PUSCH transmission.

13. The terminal device of claim 12, wherein the processor configured to determine the PO from the first MsgA PUSCH resource set according to the first repetition number of MsgA PUSCH to perform MsgA PUSCH transmission is configured to:
determine S POs from the first MsgA PUSCH resource set according to the first repetition number of MsgA PUSCH to perform MsgA PUSCH transmission, wherein a value of S is the first repetition number of MsgA PUSCH, S≤R.

14. The terminal device of claim 12, wherein the first MsgA PUSCH resource set is determined according to a mapping between a first MsgA PRACH resource set and the first MsgA PUSCH resource set, and the first MsgA PRACH resource set corresponds to K PRACH occasions (RO) in time domain and one random access preamble.

15. The terminal device of claim 14, wherein
the K ROs are consecutive in time domain; and/or
each of the K ROs corresponds to a same random access preamble; and/or
each of the K ROs corresponds to a same number of random access preambles; and/or
the K ROs constitute one RO set.

16. The terminal device of claim 14, wherein a value of K is a first repetition number of MsgA PRACH, and the first repetition number of MsgA PRACH is configured by a network or pre-configured.

17. The terminal device of claim 14, wherein the first MsgA PRACH resource set is determined according to a mapping between synchronization signal and physical broadcast channel (PBCH) blocks (SSB) and ROs.

18. The terminal device of claim 14, wherein in response to the first MsgA PUSCH resource set corresponding to R POs in time domain and one DMRS resource, a mapping rate between the first MsgA PRACH resource set and the first MsgA PUSCH resource set is:
$$\begin{matrix}L = ceil ( N / M ) \\ N = {T}_{preamble} / K \\ M = {T}_{PUSCH} / R\end{matrix}$$
wherein L represents the mapping rate, ceil(N/M) represents rounding up N/M, N represents the total number of MsgA PRACH resource sets per association pattern period, M represents the total number of MsgA PUSCH resource sets per association pattern period, T_{preamble} represents the total number of valid ROs per association pattern period multiplied by the number of random access preambles per valid RO, and T_{PUSCH} represents the total number of valid POs per association pattern period multiplied by the number of DMRS resources per valid PO.

19. The terminal device of claim 14, wherein in response to the first MsgA PUSCH resource set corresponding to R POs in time domain and one DMRS resource set, a mapping rate between the first MsgA PRACH resource set and the first MsgA PUSCH resource set is:
$$\begin{matrix}L = ceil ( N / M ) \\ N = {T}_{preamble} / K \\ M = {T}_{PUSCH} / ( {R}^{*} Z )\end{matrix}$$
wherein L represents the mapping rate, ceil(N/M) represents rounding up N/M, N represents the total number of MsgA PRACH resource sets per pattern period, M represents the total number of MsgA PUSCH resource sets per association pattern period, T_{preamble} represents the total number of valid ROs per association pattern period multiplied by the number of random access preambles per valid RO, T_{PUSCH} represents the total number of valid POs per association pattern period multiplied by the number of DMRS resources per valid PO, and Z represents the number of DMRS resources per DMRS resource set per association pattern period.

20. The terminal device of claim 12, wherein the transceiver is further configured to indicate the first repetition number of MsgA PUSCH to a network device.
